(19) United States
(12) Patent Application Publication
(10) Pub. No.: US 2025/0298679 A1
(43) Pub. Date: Sep. 25, 2025

(54) INFORMATION PROCESSING SYSTEM AND INFORMATION PROCESSING METHOD

(71) Applicant: Panasonic Automotive Systems Co., Ltd., Kanagawa (JP)

(72) Inventors: Yuta INOUE, Osaka (JP); Mitsuteru KATAOKA, Osaka (JP); Kouichi KANEMURA, Osaka (JP)

(73) Assignee: Panasonic Automotive Systems Co., Ltd., Kanagawa (JP)

(21) Appl. No.: 19/081,501

(22) Filed: Mar. 17, 2025

(30) Foreign Application Priority Data
Mar. 22, 2024 (JP) 2024-046413

(51) Int. Cl. G06F 9/54; G06F 21/60

(52) U.S. Cl. CPC G06F 9/546; G06F 21/602

(57) ABSTRACT

An information processing system includes: a higher component and a lower component. The higher component includes a message processor that transmits, to the lower component, a disclosure request message indicating a request range in which disclosure of a log data item is requested. The lower component includes a log storage storing log data items, and a disclosure executor. The disclosure executor receives the disclosure request message from the higher component, identifies, from the log storage, the log data item corresponding to the disclosure request message; determines a disclosable range of the log data item based on disclosure policy data regarding disclosure of the log data item; and transmits a disclosure log data item, which is to be disclosed in a disclosure range that is within the disclosable range and also within the request range, to the higher component, when the log data item includes the disclosure log data item.

### CROSS REFERENCE TO RELATED APPLICATION

The present application is based on and claims priority of Japanese Patent Application No. 2024-046413 filed on Mar. 22, 2024.

### FIELD

The present disclosure relates to an information processing system and the like that performs processing regarding log data items.

### BACKGROUND

Conventionally, a fault management system that obtains log information being log data items from a plurality of pieces of equipment has been proposed. Specifically, when a fault occurs in a predetermined function of a piece of equipment, the fault management system obtains log information of a log type that corresponds to the type of the piece of equipment and the function in which the fault occurs.

### CITATION LIST

### Patent Literature

PTL 1: Japanese Patent No. 7069956

### SUMMARY

However, an information processing system being a conventional fault management system can be improved upon.

Hence, the present disclosure provides an information processing system and the like that are capable of improving upon the above related art.

An information processing system according to an aspect of the present disclosure includes: a first component; and a second component, wherein the first component includes: a message processor that transmits, to the second component, a disclosure request message indicating a request range in which disclosure of a log data item is requested, the second component includes: a log storage in which one or more log data items are stored; and a disclosure executor, and the disclosure executor: receives the disclosure request message from the first component; identifies the log data item corresponding to the disclosure request message from among the one or more log data items stored in the log storage; determines a disclosable range of the log data item identified, based on a disclosure policy data item indicating, as a disclosure policy, a policy regarding disclosure of the log data item identified; and transmits a disclosure log data item to the first component, when the log data item identified includes the disclosure log data item that is to be disclosed in a disclosure range that is within the disclosable range determined and also within the request range indicated in the disclosure request message.

General or specific aspects of the present disclosure may be implemented to a device, a method, an integrated circuit, a computer program, a computer-readable recording medium such as a Compact Disc-Read Only Memory (CD-ROM), or any given combination thereof.

The information processing system according to the present disclosure can be improved upon.

Additional benefits and advantageous effects of an aspect of the present disclosure will become apparent from the description and drawings. The benefits and/or advantageous effects may be provided by embodiments, and features described and illustrated in the description and drawings. However, not all of the features are necessarily required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an example of the configuration of a communication system in Embodiment 1.

FIG. 2 is a diagram illustrating an example of the configuration of an information processing system in Embodiment 1.

FIG. 3 is a diagram for describing a technical problem to be solved in Embodiment 1.

FIG. 4 is a diagram illustrating an example of processing regarding a log data item that is performed between two components in Embodiment 1.

FIG. 5A is a diagram illustrating an example of a series of processes performed by a plurality of components in Embodiment 1.

FIG. 5B is a diagram illustrating another example of a series of processes performed by a plurality of components in Embodiment 1.

FIG. 6 is a diagram illustrating still another example of a series of processes performed by a plurality of components in Embodiment 1.

FIG. 7 is a diagram illustrating an example of the configurations of a high-level component and a plurality of low-level components in Embodiment 1.

FIG. 8 is a diagram illustrating a specific example of a high-level component and a low-level component in Embodiment 1.

FIG. 9 is a sequence diagram illustrating an example of processing operation of a high-level component and a low-level component in Embodiment 1.

FIG. 10 is a diagram illustrating an example of response information transmitted to a high-level component by an ID responder of a low-level component in Embodiment 1.

FIG. 11 is a diagram illustrating an example of a disclosure request message in Embodiment 1.

FIG. 12 is a diagram illustrating an example of a disclosure policy data item in Embodiment 1.

FIG. 13 is a diagram for describing an example of processing operation of a disclosure processor in Embodiment 1.

FIG. 14 is a diagram illustrating another example of the disclosure policy data item in Embodiment 1.

FIG. 15 is a diagram for describing another example of the processing operation of the disclosure processor in Embodiment 1.

FIG. 16 is a sequence diagram illustrating another example of the processing operation of a high-level component and a low-level component in Embodiment 1.

FIG. 17 is a diagram illustrating an example of an update message to be received by a policy updater in Embodiment 1.

FIG. 18 is a diagram illustrating an example of an update rule that is referred to by the policy updater in Embodiment 1.

FIG. 19 is a sequence diagram illustrating an example of processing operation of a policy update source and the policy updater in Embodiment 1.

FIG. 20 is a diagram illustrating an example of a series of processes performed by a plurality of components including a middle-level component in Embodiment 2.

FIG. 21 is a diagram illustrating an example of the configurations of a high-level component and a plurality of middle-level components in Embodiment 2.

FIG. 22 is a sequence diagram illustrating an example of processing operation of a high-level component, a middle-level component, and a low-level component in Embodiment 2.

### DESCRIPTION OF EMBODIMENTS

An information processing system according to a first aspect of the present disclosure includes: a first component; and a second component, wherein the first component includes: a message processor that transmits, to the second component, a disclosure request message indicating a request range in which disclosure of a log data item is requested, the second component includes: a log storage in which one or more log data items are stored; and a disclosure executor, and the disclosure executor: receives the disclosure request message from the first component; identifies the log data item corresponding to the disclosure request message from among the one or more log data items stored in the log storage; determines a disclosable range of the log data item identified, based on a disclosure policy data item indicating, as a disclosure policy, a policy regarding disclosure of the log data item identified; and transmits a disclosure log data item to the first component, when the log data item identified includes the disclosure log data item that is to be disclosed in a disclosure range that is within the disclosable range determined and also within the request range indicated in the disclosure request message. It should be noted that the first component is also referred to as a high-level component, and the second component is also referred to as a middle-level or low-level component.

Accordingly, when the second component receives the disclosure request message from the first component, the second component may transmit the disclosure log data item to the first component. Thus, the disclosure log data item is disclosed in the disclosure range that is within the disclosable range based on the disclosure policy data item and also within the request range indicated in the disclosure request message. That is, using the disclosure policy data item, the second component can disclose the disclosure log data item in the disclosure range that is narrower than the request range indicated in the disclosure request message. As a result, the second component can disclose the disclosure log data item in the disclosure range according to the necessity of the log data item, without disclosing a log data item satisfying the entire request range indicated in the disclosure request message and without refusing to disclose a log data item. For example, it is possible to disclose a disclosure log data item in a disclosure

Accordingly, the second range necessary for debugging. component can reduce the risk of the outflow of technology, and the first component can collect log data items appropriately. Note that if there is no disclosure range that is within the disclosable range based on the disclosure policy data item and also within the request range indicated in the disclosure request message, the second component need not transmit a disclosure log data item and may refuse a request with the disclosure request message.

In other words, a technical problem with an information processing system being a conventional fault management system is that the information processing system may fail to collect log data items appropriately. Hence, the first aspect of the present disclosure can collect log data items appropriately.

It is possible in the information processing system according to a second aspect of the present disclosure that the first component further includes: an extractor that extracts, from input information, first execution identification information for identifying the log data item to be requested, the message processor further generates the disclosure request message including the first execution identification information extracted by the extractor, and the disclosure executor of the second component identifies, as the log data item corresponding to the disclosure request message, a log data item to which second execution identification information corresponding to the first execution identification information has been added from among the one or more log data items stored in the log storage. It should be noted that the second aspect may depend from the first aspect. Furthermore, the first execution identification information may be identical to the second execution identification information. If the first execution identification information is associated with the second execution identification information, the first execution identification information may be different from the second execution identification information.

Accordingly, since the disclosure request message including the first execution identification information is transmitted, the first component can send, to the second component, the designation of a log data item to be requested for disclosure. With the first execution identification information, the second component can appropriately identify a log data item requested by the first component.

The information processing system according to a third aspect of the present disclosure may include: three or more components including the first component and the second component, wherein the first component further includes: a list generator that (i) transmits the first execution identification information to each of a plurality of components including the second component among the three or more components, and (ii) generates, based on a response result from one or more components each including a log data item to which the second execution identification information corresponding to the first execution identification information has been added among the plurality of components, a list indicating the one or more components including the second component, and the message processor: transmits the disclosure request message indicating, as an access target, each of the one or more components indicated in the list. It should be noted that the third aspect may depend from the second aspect.

Accordingly, before the disclosure request message is transmitted, the list indicating the one or more components each including the log data item to which the second execution identification information has been added is generated. Each of the one or more components indicated in the list is set as an access target of the disclosure request message, that is, a destination of the disclosure request message. Thus, it is possible to transmit the disclosure request message to appropriate destinations, thus making the transmission of the disclosure request message efficient. That is, it is possible to reduce needless processing such as transmitting a disclosure request message to another component other than components each including a log data item to which the second execution identification information has been added, to cause the other component to execute processing corresponding to the disclosure request message.

It is possible in the information processing system according to a fourth aspect of the present disclosure that the second component further includes: a distributor that transmits the disclosure request message received by the disclosure executor to another component except the second component among the one or more components, when the one or more components include the other component as the access target. It should be noted that the fourth aspect may depend from the third aspect.

Accordingly, the disclosure request message can be distributed from the first component to the other component via the second component. As a result, the first component can receive the disclosure log data item from also the other component, and thus it is possible to collect log data items effectively.

It is possible in the information processing system according to a fifth aspect of the present disclosure that the second component further includes: a policy storage in which one or more disclosure policy data items are stored, the one or more disclosure policy data items corresponding to the one or more log data items stored in the log storage; and a policy updater that updates the one or more disclosure policy data items, and the one or more disclosure policy data items include the disclosure policy data item corresponding to the log data item identified. It should be noted that the fifth aspect may depend from any one of the first to fourth aspects.

Accordingly, the one or more disclosure policy data items stored in the policy storage are updated, and it is thus possible to appropriately adjust a disclosure range of the disclosure log data item.

It is possible in the information processing system according to a sixth aspect of the present disclosure that the second component further includes: a processing executor that obtains, from the first component, the second execution identification information corresponding to a request each time the request is received from the first component, and executes processing corresponding to the request, and each time the processing corresponding to the request is executed, the processing executor (i) adds the second execution identification information corresponding to the request to a log data item indicating a result of the processing corresponding to the request, and (ii) stores, in the log storage, the log data item to which the second execution identification information has been added. It should be noted that the sixth aspect may depend from any one of the first to fifth aspects. The processing performed by the processing executor in response to a request from the first component may be, for example, processing performed in response to calling from Application Programming Interface (API) from the first component. Furthermore, the processing may be processing performed in response to a request in a form different from API.

Accordingly, the log storage of the second component stores, for each request from the first component, the log data item to which the second execution identification information corresponding to the request is added. In addition, the second execution identification information is information obtained from the first component. For example, the first component executes processing and requests the second component to perform other processing necessary for the processing. At this time, the first component can cause the second component to add the second execution identification information transmitted by the first component to a log data item of the other processing corresponding to the request. As a result, the first component can identify, using the second execution identification information, a log data item of a series of processes performed together with the second component.

It is possible in the information processing system according to a seventh aspect of the present disclosure that the second component further includes: a log encryptor that generates an encrypted disclosure log data item by encrypting the log data item identified or by encrypting the disclosure log data item, the disclosure executor transmits the disclosure log data item by transmitting the encrypted disclosure log data item, and the first component further includes: a log decryptor that decrypts the encrypted disclosure log data item when the first component receives the encrypted disclosure log data item. It should be noted that the seventh aspect may depend from any one of the first to sixth aspects.

Accordingly, the disclosure log data item is encrypted by the second component and transmitted to the first component. Therefore, it is possible to increase the confidentiality of the disclosure log data item. For example, the disclosure log data item that has been encrypted, that is, the encrypted disclosure log data item is transmitted from the second component to the first component via another component. In such a case, it is possible to restrain the content of the encrypted disclosure log data item from being decrypted by the other component.

It is possible in the information processing system according to an eighth aspect of the present disclosure that the disclosure policy data item indicates the disclosable range that includes a conditional clause and an execution clause, the conditional clause indicates a condition for the disclosure of the log data item identified, the execution clause indicates a first execution mode that is a mode of the disclosure of the log data item identified, the disclosure request message indicates: one or more request details for the disclosure of the log data item identified; and a second execution mode that is a mode requested for the disclosure of the log data item identified, and the disclosure executor of the second component further identifies, as the disclosure log data item, a log data item that is to be disclosed (i) in accordance with at least one request detail satisfying the condition indicated by the conditional clause among the one or more request details indicated in the disclosure request message, and (ii) in a portion of the second execution mode indicated in the disclosure request message, the portion overlapping the first execution mode indicated by the execution clause. It should be noted that the eighth aspect may depend from any one of the first to seventh aspects. For example, the request details of the disclosure request message may be a request source of the log data item, a request reason of the log data item, a disclosure destination of the log data item, or the like. The second execution mode of the disclosure request message may be, for example, a request disclosure level, a disclosure period, or the like. The condition for the disclosure policy data item may be, for example, a request source of the log data item, a disclosure destination of the log data item, a request reason for the log data item, or the like. Furthermore, the first execution mode of the disclosure policy data item may be, for example, a disclosure level, a disclosure period, or the like.

Accordingly, the disclosure log data item is disclosed in accordance with the one or more request details satisfying the condition indicated in the disclosure policy data item among the one or more request details indicated by the disclosure request message, and in the portion that is of the second execution mode indicated in the disclosure request message and overlaps the first execution mode indicated by the disclosure policy data item. Therefore, it is possible to limit a request with the request detail and the second execution mode indicated in the disclosure request message in accordance with the condition and the first execution mode indicated by the disclosure policy data item. As a result, it is possible to appropriately limit the disclosure of a log data item.

It is possible in the information processing system according to a ninth aspect of the present disclosure that when the execution clause indicates, instead of the first execution mode, an application to an external system outside the information processing system, the disclosure executor of the second component queries the external system whether or not to disclose the log data item in the second execution mode. It should be noted that the ninth aspect may depend from the eight aspect.

Accordingly, in the case where the external system permits the disclosure of the log data item in the second execution mode, it is possible to disclose a disclosure log data item in the form of the disclosure of the log data item in the second execution mode. Conversely, in the case where the external system does not permit the disclosure of the log data item in the second execution mode, it is possible to inhibit the disclosure of the log data item in the second execution mode, that is, the disclosure of the disclosure log data item. Therefore, it is possible to appropriately control the disclosure of a log data item with an external system.

The information processing system according to a tenth aspect of the present disclosure may include: three or more components including the first component and the second component, wherein the first component further includes: an aggregator that aggregates two or more disclosure log data items and outputs the two or more disclosure log data items aggregated, when the aggregator receives the two or more disclosure log data items from two or more components including the second component among the three or more components. It should be noted that the tenth aspect may depend from any one of the first to ninth aspects.

Accordingly, the two or more disclosure log data items are aggregated and output. Therefore, for example, it is possible to display the disclosure log data items on a display in an arranged manner. As a result, by referring to the disclosure log data items, for example, it is possible to easily perform the analysis of a bug or debugging.

An information processing device according to a first aspect of the present disclosure includes: an extractor that extracts, from input information, first execution identification information for identifying a log data item to be requested; a list generator that (i) transmits the first execution identification information to each of a plurality of external devices, and (ii) generates, based on a response result from one or more external devices each including a log data item to which second execution identification information corresponding to the first execution identification information has been added among the plurality of external devices, a list indicating the one or more external devices; and a message processor that transmits a disclosure request message indicating a request range in which disclosure of the log data item is requested, to at least one of the one or more external devices indicated in the list, wherein the disclosure request message includes the first execution identification information extracted by the extractor, and indicates the one or more external devices indicated in the list as access targets. For example, the information processing device corresponds to the above-described first component, and the external device corresponds to the above-described second component.

Accordingly, the information processing device can obtain a log data item according to the request range from at least one of the one or more external devices by transmitting the disclosure request message to the at least one external device. Since the disclosure request message including the first execution identification information is transmitted, the information processing device can send, to the external device, the designation of a log data item to be requested for disclosure. With the first execution identification information, the external device can appropriately identify a log data item requested by the information processing device. In addition, before the disclosure request message is transmitted, the list indicating the one or more external devices each including the log data item to which the second execution identification information has been added is generated. Each of the one or more external devices indicated in the list is set as an access target of the disclosure request message, that is, a destination of the disclosure request message. Thus, it is possible to transmit the disclosure request message to appropriate destinations, thus making the transmission of the disclosure request message efficient. That is, it is possible to reduce needless processing such as transmitting a disclosure request message to another external device other than external devices each including a log data item to which the second execution identification information has been added, to cause the other external device to execute processing corresponding to the disclosure request message. As a result, it is possible to appropriately collect log data items.

An information processing device according to a second aspect of the present disclosure includes: a log storage in which one or more log data items are stored; and a disclosure executor, wherein the disclosure executor: receives, from an external device, a disclosure request message indicating a request range in which disclosure of a log data item is requested; identifies the log data item corresponding to the disclosure request message from among the one or more log data items stored in the log storage; determines a disclosable range of the log data item identified, based on a disclosure policy data item indicating, as a disclosure policy, a policy regarding disclosure of the log data item identified; and transmits a disclosure log data item to the external device, when the log data item identified includes the disclosure log data item that is to be disclosed in a disclosure range that is within the disclosable range determined and also within the request range indicated in the disclosure request message. For example, the information processing device corresponds to the above-described second component, and the external device corresponds to the above-described first component.

Accordingly, when the information processing device receives the disclosure request message from the external device, the information processing device may transmit the disclosure log data item to the external device. Thus, the disclosure log data item is disclosed in the disclosure range that is within the disclosable range based on the disclosure policy data item and also within the request range indicated in the disclosure request message. That is, using the disclosure policy data item, the information processing device can disclose the disclosure log data item in the disclosure range that is narrower than the request range indicated in the disclosure request message. As a result, the information processing device can disclose the disclosure log data item in the disclosure range according to the necessity of the log data item, without disclosing a log data item satisfying the entire request range indicated in the disclosure request message and without refusing to disclose a log data item. For example, it is possible to disclose a disclosure log data item in a disclosure range necessary for debugging. Accordingly, the external device can appropriately collect log data items. Note that if there is no disclosure range that is within the disclosable range based on the disclosure policy data item and also within the request range indicated in the disclosure request message, the information processing device need not transmit a disclosure log data item.

An information processing device according to a third aspect of the present disclosure includes: a message processor that transmits, to a first external device, a first disclosure request message indicating a request range in which disclosure of a log data item is requested; a log storage in which one or more log data items are stored; and a disclosure executor, wherein the disclosure executor: receives a second disclosure request message indicating the request range from a second external device; identifies the log data item corresponding to the second disclosure request message from among the one or more log data items stored in the log storage; determines a disclosable range of the log data item identified, based on a disclosure policy data item indicating, as a disclosure policy, a policy regarding disclosure of the log data item identified; and transmits a disclosure log data item to the second external device, when the log data item identified includes the disclosure log data item that is to be disclosed in a disclosure range that is within the disclosable range determined and also within the request range indicated in the second disclosure request message. For example, the information processing device corresponds to a component including both of the function of the above-described first component and the function of the above-described second component.

With this, the information processing device can produce the same advantageous effects as those of the above-described information processing device according to the second aspect, and can request a log data item from the first external device in the same manner as the above-described information processing device according to the first aspect.

Hereinafter, certain exemplary embodiments will be described in detail with reference to the accompanying Drawings.

The following embodiments are specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements. In addition, the diagrams are schematic representations, and thus are not necessarily true to scale. Also, in the diagrams, structural elements that are the same are given the same reference numerals.

### Embodiment 1

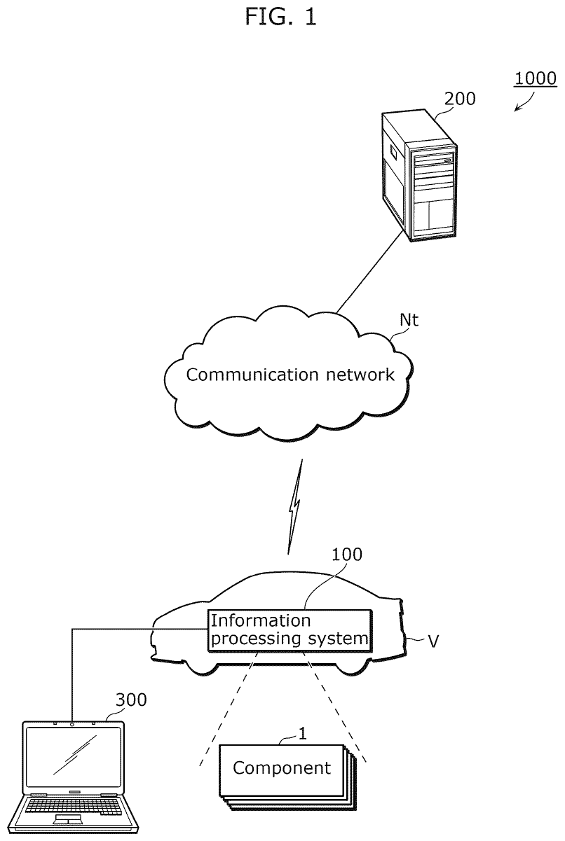

FIG. 1 is a diagram illustrating an example of the configuration of a communication system in the present embodiment.

Communication system 1000 in the present embodiment is, for example, a system that analyzes a bug or debugs.

Communication system 1000 includes information processing system 100, server 200, and debugging device 300.

Information processing system 100 is, for example, a system that is provided in vehicle V. Information processing system 100 includes a plurality of components 1. Each of components 1 is a unit, a device, or an apparatus that executes processing corresponding to such component 1 and retains a log data item about the executed processing. A log data item indicates, for example, an input, an output, and a state of processing when the processing is executed.

Server 200 is connected to information processing system 100 via communication network Nt. Server 200 obtains one or more log data items from information processing system 100 via communication network Nt. For example, on the basis of the one or more log data items, server 200 performs processing such as analyzing a bug or debugging for information processing system 100.

Debugging device 300 is, for example, connected to information processing system 100 and obtains one or more log data items that are aggregated by information processing system 100. As with server 200, on the basis of the one or more log data items, debugging device 300 performs processing such as analyzing a bug or debugging for information processing system 100.

Note that the configuration of communication system 1000 illustrated in FIG. 1 is merely an example. Communication system 1000 may have another configuration as long as the configuration includes information processing system 100.

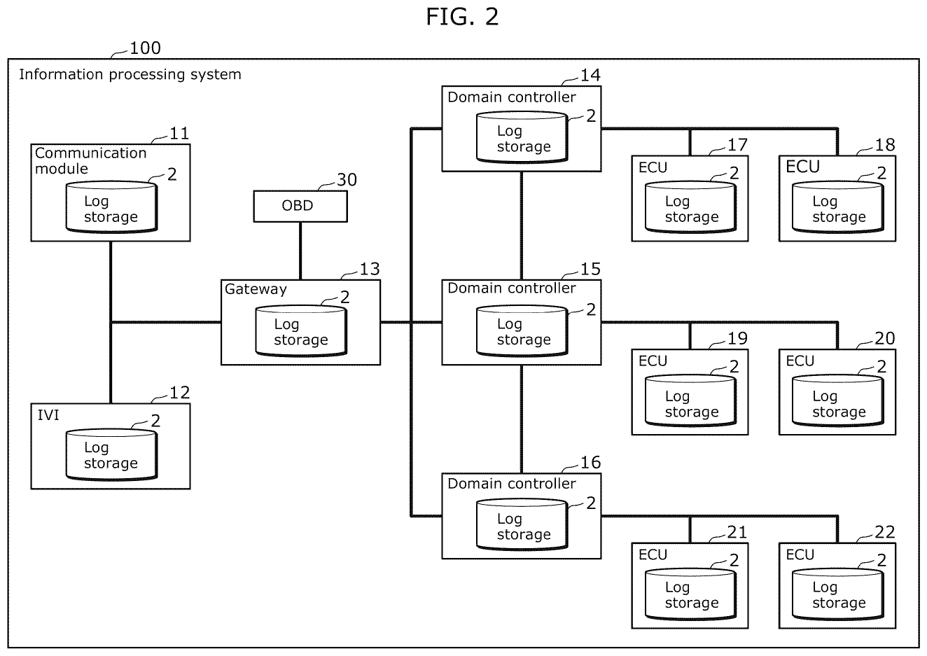

FIG. 2 is a diagram illustrating an example of the configuration of information processing system 100 in the present embodiment.

Information processing 100 system includes communication module 11, in-vehicle infotainment (IVI) 12, gateway 13, three domain controllers 14 to 16, and six electronic control units (ECUs) 17 to 22, as components 1. Information processing system 100 may include on-board diagnostics (OBD) 30.

The plurality of components 1 included in information processing system 100, that is, communication module 11, IVI 12, gateway 13, three domain controllers 14 to 16, and six ECUs 17 to 22 each include log storage 2.

Log storage 2 is a recording medium for storing a log data item about processing executed in component 1 that includes such log storage 2. That is, log storage 2 stores one or more log data items. For example, log storage 2 is a hard disk drive, a random access memory (RAM), a read only memory (ROM), a semiconductor memory, or the like. Note that such log storage 2 may be either volatile or nonvolatile.

Note that the configuration of information processing system 100 illustrated in FIG. 2 is merely an example. Information processing system 100 may have another configuration as long as the configuration includes the plurality of components 1. Furthermore, information processing system 100 may have a virtualized configuration rather than a physical configuration. That is, each of the plurality of components 1 may be configured as a virtual machine. Furthermore, vehicle V including such information processing system 100 may be configured as a software defined vehicle (SDV).

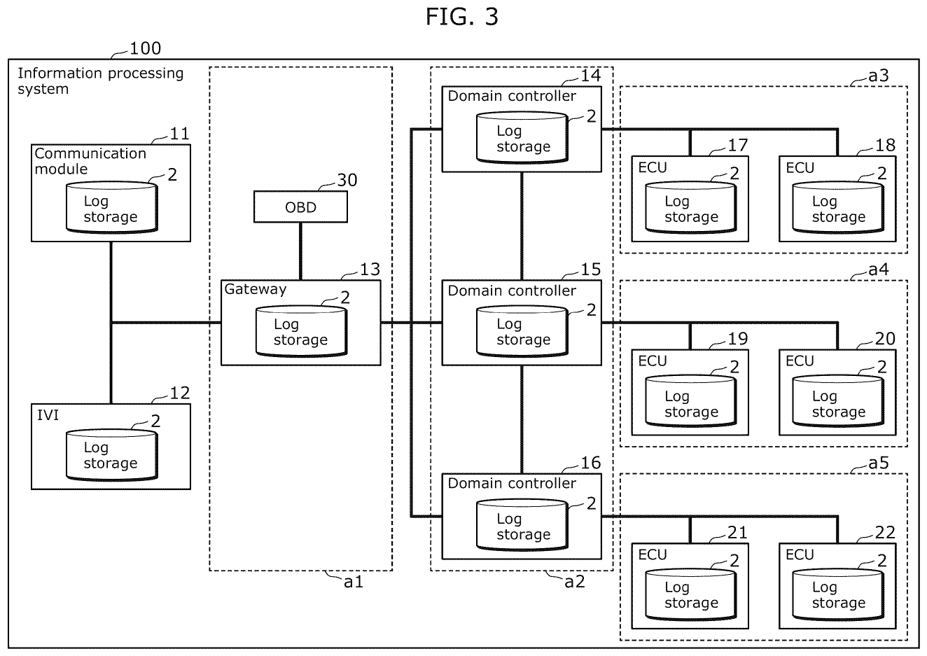

FIG. 3 is a diagram for describing a technical problem to be solved in the present embodiment.

For example, in information processing system 100, constituent element group a1 including OBD 30 and gateway 13 is developed by vendor A. In addition, in information processing system 100, constituent element group a2 including three domain controllers 14 to 16 is developed by vendor B. In information processing system 100, constituent element group a3 including two ECUs 17 and 18 is developed by vendor C, constituent element group a4 including two ECUs 19 and 20 is developed by vendor D, and constituent element group a5 including two ECUs 21 and 22 is developed by vendor E. As seen from the above, information processing system 100 may include a plurality of constituent element groups developed by different vendors.

In such a case, if each of the plurality of components 1 included in information processing system 100 is configured as a conventional component, it is not easy to transmit and receive log data items among the plurality of constituent element groups. That is, for example, the conventional component may constantly refuse the transmission of a log data item to another component developed by a vendor different from a vendor of the conventional component. As a result, for example, if one component 1 collects a plurality of log data items generated when a series of processes is executed by the plurality of constituent element groups for debugging, it may not be possible to collect the plurality of log data items. Alternatively, it may not be possible to collect log data items all because the transmission of all of the log data items needs a long time, a high consumption of processing resources, or a high cost.

Hence, in information processing system 100 in the present embodiment, upon receiving a request for a log data item from another component 1, component 1 transmits its log data item to the other component 1 according to a disclosure policy data item.

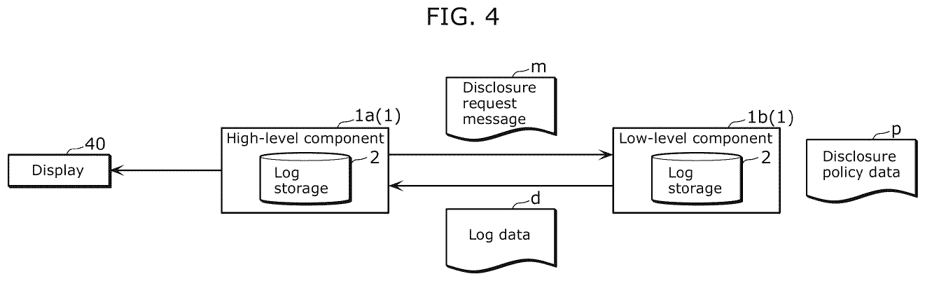

FIG. 4 is a diagram illustrating an example of processing regarding a log data item that is performed between two components 1 in the present embodiment.

For example, processing regarding log data item d is performed between two components 1 among the plurality of components 1 included in information processing system 100, that is, between high-level component 1a and low-level component 1b. That is, information processing system 100 in the present embodiment includes high-level component 1a and low-level component 1b. High-level component 1a is also called a first component, and low-level component 1b is also called a second component.

Specifically, high-level component 1a transmits disclosure request message m to low-level component 1b. Receiving such disclosure request message m, low-level component 1b refers to disclosure policy data item p retained by low-level component 1b. Low-level component 1b then transmits, to high-level component 1a, a disclosure policy indicated by disclosure policy data item p and log data item d corresponding to disclosure request message m. Transmitted log data item d may be stored in log storage 2 of low-level component 1b or may be a log data item processed from a log data item stored in log storage 2. Note that log data item d is also called a disclosure log data item. Obtaining log data item d from low-level component 1b, high-level component 1a displays such log data item d on display 40. For example, display 40 may be a display that is disposed on a dashboard of vehicle V and controlled by IVI 12 or may be a display of debugging device 300. Obtaining a plurality of log data items d, high-level component 1a may aggregate the plurality of log data items d and display the plurality of log data items d aggregated on display 40.

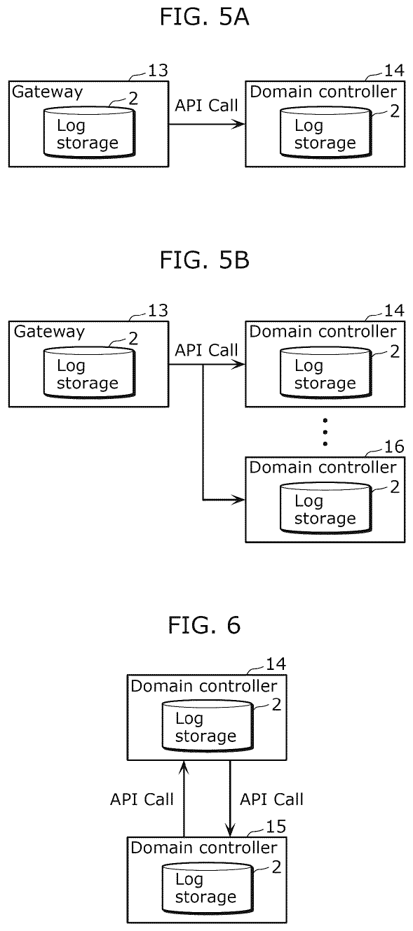

FIG. 5A, FIG. 5B, and FIG. 6 are diagrams each illustrating an example of the series of processes performed by the plurality of components 1 in the present embodiment.

For example, as illustrated in FIG. 5A, gateway 13 calls a function of domain controller 14 via an application programming interface (API) to execute a process. As a result, domain controller 14 executes a process corresponding to the called function. Domain controller 14 then transmits a result of the process to gateway 13, and using the result of the process, gateway 13 may further perform a process. Accordingly, the series of processes is executed by gateway 13 and domain controller 14. In the example in FIG. 5A, gateway 13 executes the process as high-level component 1a, and domain controller 14 executes the process as low-level component 1b. Domain controller 14 belongs to a layer directly below gateway 13.

As illustrated in FIG. 5B, gateway 13 may call a function of each of a plurality of domain controllers 14, 15, and 16 via an API. In this case, domain controllers 14, 15, and 16 belong to the same layer directly below gateway 13.

As illustrated in FIG. 6, to execute a process, domain controller 14 calls a function of domain controller 15 via an API. As a result, domain controller 15 executes a process corresponding to the called function. To execute a process, domain controller 15 may call a function of domain controller 14 via an API. That is, the call of an API may be performed bidirectionally. Accordingly, the series of processes is executed by domain controllers 14 and 15. In the example in FIG. 6, each of domain controllers 14 and 15 executes the process as high-level component 1a and low-level component 1b.

In the present embodiment, when processing is performed by each of components 1, a log data item corresponding to a result of the processing is stored in log storage 2 of such component 1. In addition, when the series of processes as mentioned above is performed, each of the plurality of components 1 performing the series of processes stores a log data item on a process executed by such component 1 in log storage 2. At this time, the plurality of components 1 store the log data items in log storages 2 after adding, to the log data items, execution identification information items that are associated with one another among the plurality of components 1. For example, the execution identification information may be information that is common or identical among the plurality of components 1.

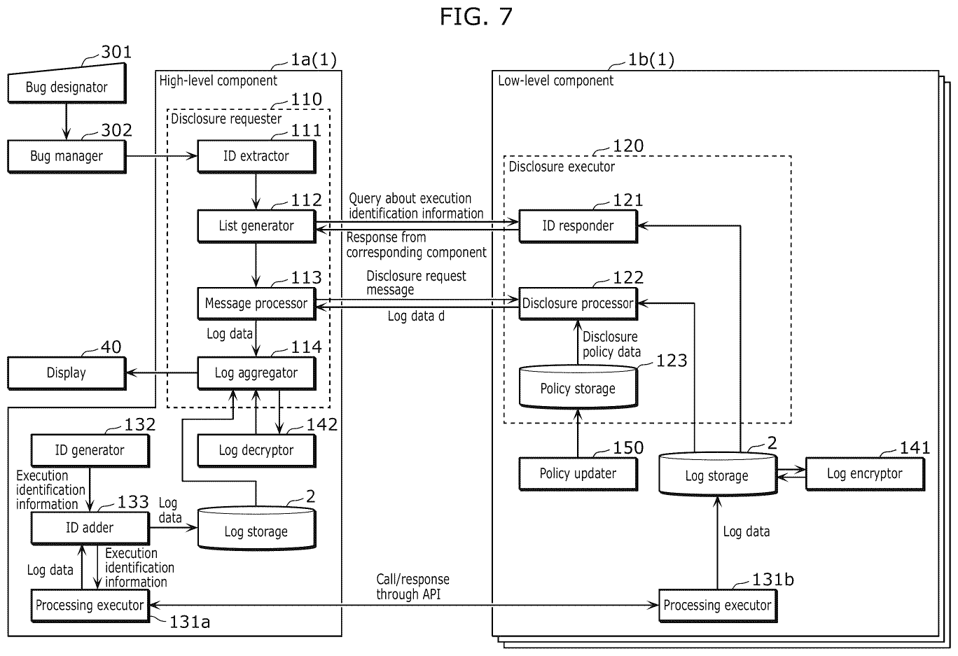

FIG. 7 is a diagram illustrating an example of the configurations of high-level component 1a and a plurality of low-level components 1b in the present embodiment.

High-level component 1a includes log storage 2, disclosure requester 110, processing executor 131a, ID generator 132, ID adder 133, and log decryptor 142.

ID generator 132 generates the above-mentioned execution identification information and outputs the execution identification information to ID adder 133. ID adder 133 obtains the execution identification information from ID generator 132 and outputs the execution identification information to processing executor 131a. In addition, upon obtaining a log data item from processing executor 131a, ID adder 133 adds the execution identification information generated by ID generator 132 to the log data item. ID adder 133 then stores, in log storage 2, the log data item to which the execution identification information has been added. Note that the execution identification information that is generated by ID generator 132 and added to the log data item by ID adder 133 is also called second execution identification information.

Processing executor 131a executes a process included in the above-mentioned series of processes and calls a function of low-level component 1b via an API. At this time, processing executor 131a obtains the execution identification information generated by ID generator 132 via ID adder 133 and outputs the execution identification information to low-level component 1b. In addition, after receiving, through the call via the API, a result of a process by the function as a response from low-level component 1b, processing executor 131a executes a process using the result of the process. Such a call through an API may be performed on a plurality of low-level components 1b. Accordingly, the series of processes is executed. Processing executor 131a then outputs a log data item of the process executed by processing executor 131a to ID adder 133.

Disclosure requester 110 requests low-level component 1b to disclose a log data item. Disclosure requester 110 includes ID extractor 111, list generator 112, message processor 113, and log aggregator 114.

ID extractor 111 is an extractor that obtains input information from bug manager 302 and extracts execution identification information from the input information. Note that the execution identification information extracted by ID extractor 111 is also called first execution identification information in the case where the execution identification information is distinguished from the second execution identification information generated by ID generator 132 mentioned above. The first execution identification information is information for identifying a log data item to be requested. For example, debugging device 300 includes bug designator 301 that designates a bug in accordance with an input operation by a user, and includes bug manager 302 that outputs, as the input information, information about the designated bug by bug designator 301 to high-level component 1a. The input information includes execution identification information relating to the designated bug. ID extractor 111 extracts the execution identification information and outputs the execution identification information to list generator 112.

List generator 112 transmits the execution identification information (i.e., first execution identification information) to a plurality of low-level components 1b included in information processing system 100. Accordingly, list generator 112 queries each of such components 1 as to whether such components 1 retain a log data item to which the execution identification information has been added. That is, list generator 112 queries whether component 1 retains a log data item to which second execution identification information corresponding to the first execution identification information extracted by ID extractor 111 has been added. For example, the second execution identification information is the same as the first execution identification information. Note that the second execution identification information may differ from the first execution identification information as long as the association between the second execution identification information and the first execution identification information is defined. List generator 112 then generates a list indicating one or more low-level components 1b responding that they retain the log data item, and outputs the list to message processor 113.

That is, in the present embodiment, information processing system 100 includes three or more components 1 including high-level component 1a and low-level component 1b. List generator 112 transmits the execution identification information to each of a plurality of components 1 including low-level component 1b. Next, list generator 112 generates, on the basis of a response result from one or more components 1 each including a log data item to which the execution identification information has been added among the plurality of components 1, a list indicating the one or more components 1. In other words, list generator 112 transmits the first execution identification information to each of the plurality of components 1 including low-level component 1b, and generates, on the basis of a response result from one or more components 1 each including a log data item to which the second execution identification information corresponding to the first execution identification information has been added among the plurality of components 1, a list indicating the one or more components 1 including low-level component 1b.

Message processor 113 generates disclosure request message m indicating a request range in which the disclosure of a log data item is requested, and transmits disclosure request message m to low-level components 1b. Specifically, upon obtaining the generated list from list generator 112, message processor 113 generates disclosure request message m mentioned above indicating the request range in which the disclosure of the log data item is requested, and transmits disclosure request message m to low-level components 1b indicated in the list. That is, message processor 113 generates disclosure request message m including the execution identification information (i.e., the first execution identification information) extracted by ID extractor 111. In addition, message processor 113 transmits disclosure request message m indicating, as an access target, each of one or more components 1 indicated in the list.

Obtaining log data items d corresponding to such disclosure request message m from one or more low-level components 1b, message processor 113 outputs such log data items d to log aggregator 114. Note that log data items d transmitted from low-level components 1b responding to disclosure request message m are log data items that such low-level components 1b determine to be disclosed, and are also called disclosure log data items.

Log aggregator 114 obtains and aggregates one or more log data items d from message processor 113. Here, in the case where any one or some log data items d of such one or more log data items d have been encrypted, log aggregator 114 instructs log decryptor 142 to decrypt such encrypted log data items d and obtains decrypted log data items d from log decryptor 142. As seen from the above, when log aggregator 114 in the present embodiment receives log data items d from two or more components 1 including low-level component 1b, log aggregator 114 aggregates such two or more log data items d and outputs aggregated two or more log data items d. For example, log aggregator 114 aggregates such log data items d and outputs aggregated log data items d to display 40. When a log data item to which the execution identification information extracted by ID extractor 111 has been added is stored in log storage 2 of high-level component 1a, log aggregator 114 obtains the log data item from log storage 2. That is, when a log data item to which the second execution identification information corresponding to the first execution identification information extracted by ID extractor 111 has been added is stored in log storage 2 of high-level component 1a, log aggregator 114 obtains the log data item from log storage 2. Log aggregator 114 then aggregates the log data item obtained from log storage 2 together with one or more log data items d obtained from message processor 113 and outputs a plurality of log data items aggregated to display 40.

Log decryptor 142 obtains encrypted log data items d from log aggregator 114, decrypts such log data items d, and outputs decrypted log data items d to log aggregator 114. That is, when high-level component 1a receives encrypted disclosure log data items, which are encrypted log data items d, log decryptor 142 decrypts the encrypted disclosure log data items.

Low-level component 1b includes log storage 2, disclosure executor 120, processing executor 131b, log encryptor 141, and policy updater 150.

Processing executor 131b executes, in response to a call of a function through an API from high-level component 1a, a process corresponding to the function and passes, for example, a result of the process to high-level component 1a. Processing executor 131b then stores a log data item of the process executed by processing executor 131b in log storage 2 of low-level component 1b. Here, when the call through an API is performed, processing executor 131b obtains, together with the call, execution identification information (i.e., second execution identification information) from high-level component 1a. Thus, processing executor 131b adds the execution identification information from high-level component 1a to the log data item and stores the log data item in log storage 2.

In the case where the execution identification information from high-level component 1a includes a time point at which high-level component 1a executes a process, processing executor 131b may replace the time point with a time point at which processing executor 131b executes the process. Alternatively, processing executor 131b may add, to the log data item, not only the execution identification information (i.e., the second execution identification information) but also another type of identification information unique to low-level component 1b.

As seen from the above, for each request through an API from high-level component 1a, processing executor 131b obtains second execution identification information corresponding to the request from high-level component 1a and executes a process corresponding to the request. Each time the process corresponding to the request is executed, processing executor 131b adds the second execution identification information corresponding to the request to a log data item indicating a result of the process corresponding to the request. Processing executor 131b further stores, in log storage 2 of low-level component 1b, the log data item to which the second execution identification information has been added.

Log encryptor 141 encrypts some or all of one or more log data items stored in log storage 2. For example, when one or more log data items corresponding to disclosure request message m are identified by disclosure processor 122, log encryptor 141 encrypts the identified one or more log data items stored in log storage 2. In addition, log encryptor 141 encrypts disclosure log data items corresponding to the identified one or more log data items. Accordingly, log encryptor 141 generates the encrypted disclosure log data items. Note that log encryptor 141 may encrypt the disclosure log data item using an encryption key that is retained in common with component 1 being a requestor of the log data item (i.e., high-level component 1a) (i.e., common-key). Note that common-key cryptography or the like may be used to encrypt the disclosure log data item such that only specific component 1 can perform decryption or to prevent spoofing.

Disclosure executor 120 includes ID responder 121, disclosure processor 122, and policy storage 123. Upon receiving a query from list generator 112 of high-level component 1a, ID responder 121 responds to the query. That is, ID responder 121 receives execution identification information from list generator 112 and receives a query as to whether a log data item to which the execution identification information has been added is retained. In other words, ID responder 121 receives first execution identification information from list generator 112 and receives a query as to whether a log data item to which second execution identification information corresponding to the first execution identification information has been added is retained. ID responder 121 then searches log storage 2 for the log data item to which the execution identification information (i.e., the second execution identification information) has been added. When the log data item is present in log storage 2, ID responder 121 responds the query by transmitting component identification information for identifying low-level component 1b including such ID responder 121 to list generator 112.

Policy storage 123 is a recording medium that stores disclosure policy data item p indicating a policy regarding the disclosure of a log data item stored in log storage 2 of low-level component 1b. That is, policy storage 123 stores one or more disclosure policy data items p corresponding to one or more log data items stored in log storage 2. When one or more log data items corresponding to disclosure request message m are identified by disclosure processor 122, such one or more disclosure policy data items p include one or more disclosure policy data items p corresponding to the identified log data items. For example, policy storage 123 is a hard disk drive, a RAM, a ROM, or a semiconductor memory, or the like. Note that such policy storage 123 may be either volatile or nonvolatile.

When disclosure processor 122 receives disclosure request message m from message processor 113 of high-level component 1a, disclosure processor 122 searches log storage 2 for a log data item that is requested with such disclosure request message m. That is, disclosure processor 122 receives disclosure request message m from high-level component 1a and identifies a log data item corresponding to such disclosure request message m from among one or more log data items stored in log storage 2 of low-level component 1b. Specifically, disclosure processor 122 identifies, as the log data item corresponding to disclosure request message m, a log data item to which second execution identification information corresponding to first execution identification information included in disclosure request message m has been added from among the one or more log data items stored in log storage 2 of low-level component 1b.

Disclosure processor 122 then obtains disclosure policy data item p corresponding to the identified log data item from policy storage 123. Disclosure processor 122 then determines a disclosable range of the log data item on the basis of such disclosure policy data item p. That is, disclosure processor 122 determines the disclosable range of the identified log data item, on the basis of disclosure policy data item p indicating, as a disclosure policy, a policy regarding the disclosure of the identified log data item. Furthermore, disclosure processor 122 transmits a disclosure log data item to high-level component 1a when the identified log data item includes the disclosure log data item that is to be disclosed in a disclosure range that is within the determined disclosable range and also within a request range indicated in disclosure request message m. Disclosure processor 122 may use some or all of log data items identified as mentioned above, as disclosure log data items, and may generate disclosure log data items from the log data items. In the case where a disclosure log data item is encrypted by log encryptor 141, disclosure processor 122 transmits the disclosure log data item by transmitting an encrypted disclosure log data item.

Policy updater 150 updates one or more disclosure policy data items p stored in policy storage 123.

As mentioned above, in the present embodiment, types of execution identification information such as the first execution identification information and the second execution identification information are used. Accordingly, it is possible to confine components 1 and log data items relating to a bug focused on by debugging device 300. Note that the execution identification information may be constituted by a sequence ID or a combination of a process name and a time range.

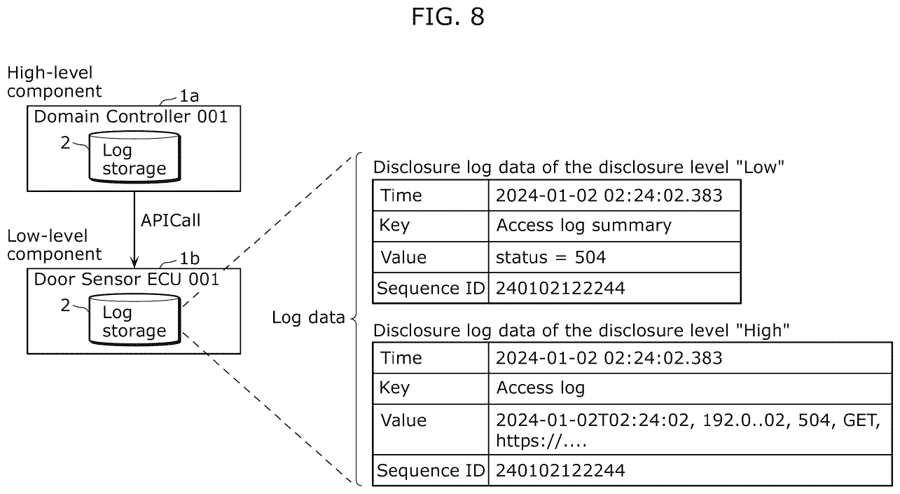

FIG. 8 is a diagram illustrating a specific example of high-level component 1a and low-level component 1b.

High-level component 1a is, for example, component 1 having the name “Domain Controller 001”. Low-level component 1b is, for example, component 1 having the name “Door Sensor ECU 001.”

In log storage 2 of low-level component 1b, for example, log data items including two types of disclosure log data items are stored. The two types of disclosure log data items are a disclosure log data item of the disclosure level “Low” and a disclosure log data item of the disclosure level “High.” These disclosure log data items each include the same sequence number “240102122244” as execution identification information and each include the same date and time “2024 Jan. 2 02:24:02.383.” Meanwhile, the disclosure log data item of the disclosure level “High” includes Key and Value each having more detailed information than the disclosure log data item of the disclosure level “Low.” Note that the disclosure log data item of the disclosure level “Low” may be generated from the disclosure log data item of the disclosure level “High.”

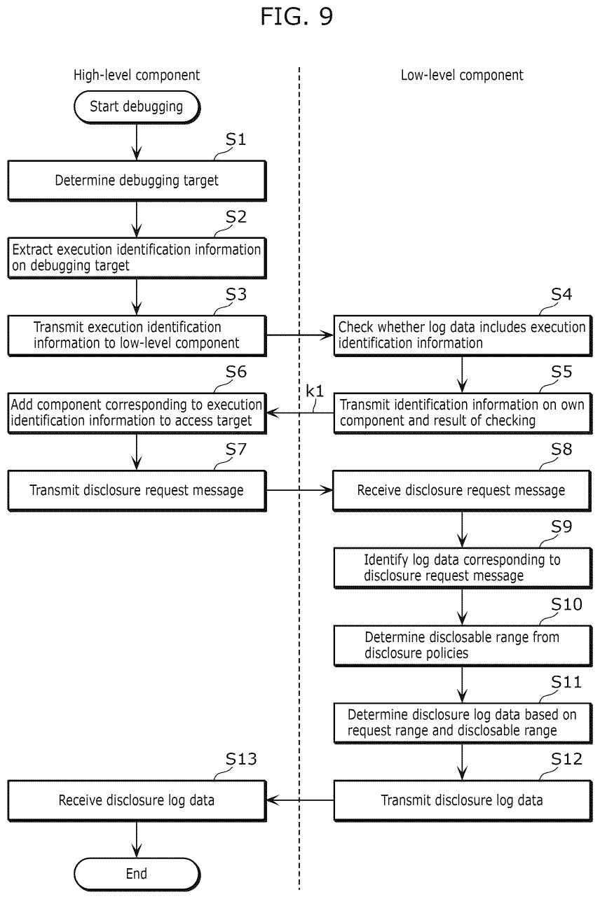

FIG. 9 is a sequence diagram illustrating an example of processing operation of high-level component 1a and low-level component 1b.

First, when debugging is started, ID extractor 111 of high-level component 1a determines a series of processes to be a debugging target (step S1). The debugging target may be designated by debugging device 300. In addition, the debugging target may be a series of processes in which an error has occurred, a series of processes that respond slow, a series of processes that fails, a series of processes in which an unusual event has occurred, or the like. Alternatively, a specific debugging target may be designated by a person performing the debugging who intends to simply check whether the series of processes is normally executed even when the series of processes is no different from a normal series of processes. ID extractor 111 further extracts execution identification information on the determined debugging target from the input information mentioned above (step S2).

List generator 112 then transmits the execution identification information to low-level component 1b to query such low-level component 1b (step S3). When ID responder 121 receives the execution identification information from high-level component 1a, ID responder 121 checks whether a log data item to which the execution identification information has been added is stored in log storage 2 of low-level component 1b (step S4). That is, ID responder 121 checks whether any log data item stored in log storage 2 includes the execution identification information.

In other words, ID responder 121 searches log storage 2 for a log data item to which the execution identification information has been added. Note that, when log data items are stored in a log file, ID responder 121 searches the log file for the log data item to which the execution identification information has been added.

Here, ID responder 121 checks that a log data item includes the execution identification information. At this time, ID responder 121 transmits, to high-level component 1a, response information k1 that includes a result of the checking and component identification information, which is identification information on low-level component 1b including such ID responder 121 (i.e., identification information on the own component) (step S5). Note that the result of the checking indicates that the log data item in low-level component 1b identified with the component identification information includes the execution identification information mentioned above, that is, indicates that identified low-level component 1b has the log data item including the execution identification information.

List generator 112 receives response information k1 from low-level component 1b. List generator 112 then generates the list mentioned above. The list indicates the component identification information included in received response information k1. Note that when list generator 112 receives response information k1 from each of a plurality of low-level components 1b, the list indicates a plurality of component identification information items.

Message processor 113 then adds, to access targets, low-level component 1b identified with one or more component identification information items indicated by the list (step S6). That is, message processor 113 adds, to the access targets, each of one or more low-level components 1b corresponding to the execution identification information extracted in step S2. The access targets are destinations of disclosure request message m. Message processor 113 then transmits disclosure request message m to the access targets (step S7).

Disclosure processor 122 of low-level component 1b receives disclosure request message m from high-level component 1a (step S8). Disclosure processor 122 further checks whether component identification information on low-level component 1b including such disclosure processor 122 is set to the access targets of such disclosure request message m. When the component identification information is set, disclosure processor 122 identifies a log data item corresponding to such disclosure request message m (step S9). In addition, disclosure processor 122 reads disclosure policy data item p corresponding to the identified log data item from policy storage 123 and determines a disclosable range indicated by such disclosure policy data item p (step S10). Then, on the basis of a request range of disclosure request message m and the disclosable range, disclosure processor 122 identifies a disclosure log data item (step S11) and transmits the disclosure log data item to high-level component 1a (step S12). As a result, high-level component 1a receives the disclosure log data item from low-level component 1b (step S13). Accordingly, the disclosure log data item is disclosed.

That is, the disclosure log data item is displayed by high-level component 1a on display 40 mentioned above. When high-level component 1a receives a plurality of disclosure log data items from a plurality of low-level components 1b, the plurality of disclosure log data items are displayed on display 40. At this time, the plurality of disclosure log data items are displayed in an integrated or aggregated manner. For example, the plurality of disclosure log data items may be displayed in such a manner as to be arranged in a time-series order in a table format. The plurality of disclosure log data items may be output in such a manner as to be attached to an email or may be output in a file format. The display of the received disclosure log data item is not limited to the display of a primary log data item and may be the display of a result or the like obtained by analyzing the log data item.

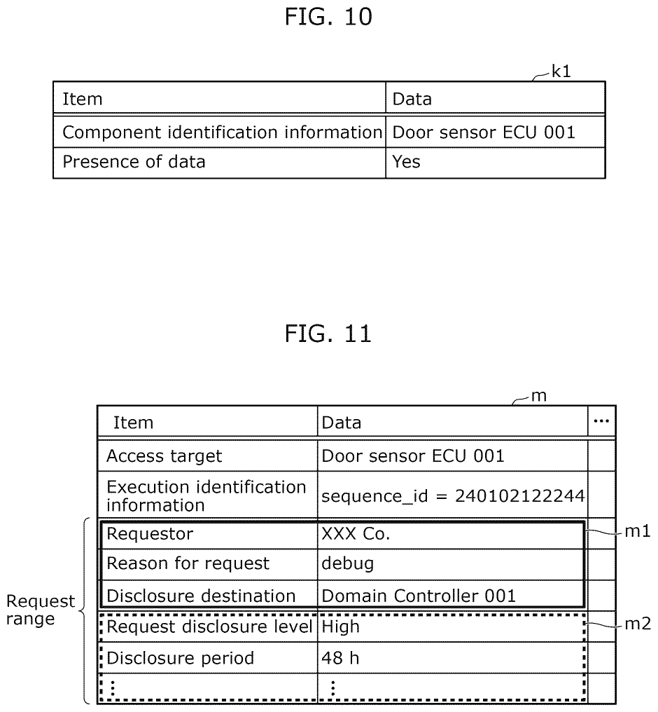

FIG. 10 is a diagram illustrating an example of response information k1 transmitted to high-level component 1a by ID responder 121 of low-level component 1b.

In step S5 in FIG. 9, ID responder 121 transmits, for example, response information k1 illustrated in FIG. 10 to high-level component 1a. Response information k1 indicates component identification information for identifying low-level component 1b including such ID responder 121 and indicates the presence or absence of data. The presence or absence of data is the result of the checking mentioned above. Specifically, the presence or absence of data means whether a log data item to which second execution identification information corresponding to first execution identification information has been added is stored in log storage 2 of low-level component 1b. Note that the “presence” of the presence or absence of data means that the log data item is stored.

FIG. 11 is a diagram illustrating an example of disclosure request message m.

Disclosure request message m includes the name of an access target, execution identification information, first request information m1 and second request information m2. The execution identification information is first execution identification information. In a specific example, the name of the access target is the name of component 1 “Door sensor ECU 001,” and the execution identification information (e.g., sequence ID) is “240102122244.” First request information m1 and second request information m2 each indicate a request range in which the disclosure of a log data item is requested.

When a log data item corresponding to disclosure request message m is identified, first request information m1 indicates one or more request details for the disclosure of the identified log data item. The one or more request details includes, for example, a requestor, a reason for the request, a disclosure destination. The requestor is the name of a company, a device, a person, or the like requesting the disclosure. A specific example of the request source is “XXX Co.” The reason for the request is a reason for requesting the disclosure. A specific example of the reason for the request is “debug.” The disclosure destination is a disclosure destination of the log data item. For example, the disclosure destination is component 1. A specific example of the disclosure destination is component 1 having the name “Domain Controller 001.”

Second request information m2 indicates a second execution mode, which is a mode requested for the disclosure of the identified log data item. The second execution mode includes, for example, a request disclosure level and a disclosure period. The request disclosure level is a level or a disclosure level requested for an amount of information included in the log data item to be disclosed. The request disclosure level “High” means that the requested amount of information is large, and the request disclosure level “Low” means that the requested amount of information is smaller than the amount of information meant by the request disclosure level “High.” Note that the request disclosure level can be regarded as an abstraction level requested for the log data item to be disclosed. In this case, the request disclosure level “High” means that a detailed and concrete disclosure of a log data item is requested, and the request disclosure level “Low” means that a more abstracted or simplified log data item than the log data item at the request disclosure level “High” is requested. The disclosure period is the period of disclosure requested for the log data item. In the example in FIG. 11, second request information m2 indicates the request disclosure level “High” and the disclosure period “48 h.”

Note that disclosure request message m illustrated in FIG. 11 is transmitted, for example, from high-level component 1a to low-level component 1b illustrated in FIG. 8.

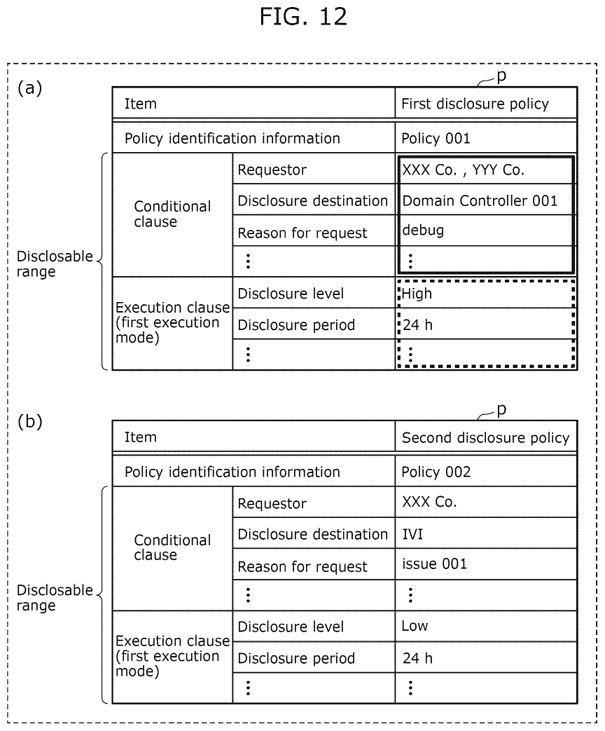

FIG. 12 is a diagram illustrating an example of disclosure policy data item p.

For example, policy storage 123 stores disclosure policy data item p indicating a first disclosure policy as illustrated in (a) in FIG. 12 and stores disclosure policy data item p indicating a second disclosure policy as illustrated in (b) in FIG. 12. As seen from the above, disclosure policy data item p indicates disclosure policies. Note that policy storage 123 may store another disclosure policy data item p that indicates a disclosure policy different from the first disclosure policy and the second disclosure policy.

Disclosure policy data item p includes policy identification information for identifying a disclosure policy and includes a disclosable range. The disclosable range includes a conditional clause and an execution clause. That is, disclosure policy data item p in the present embodiment indicates the disclosable range that includes the conditional clause and the execution clause. When a log data item corresponding to disclosure request message m is identified, the conditional clause indicates a condition for the disclosure of the identified log data item. For example, the conditional clause indicates a requestor, a disclosure destination, a reason for a request, and the like as a condition. The execution clause indicates a first execution mode that is a mode of the disclosure of the identified log data item. For example, the execution clause indicates a disclosure level, a disclosure period, and the like as the first execution mode. The disclosure level of the execution clause is a level that is permitted for an amount of information included in the log data item to be disclosed. The disclosure period of the execution clause is a period of disclosure permitted for the log data item.

In a specific example, as illustrated in (a) in FIG. 12, disclosure policy data item p includes the policy identification information “Policy 001.” The conditional clause of such disclosure policy data item p indicates the requestor “XXX Co., YYY Co.,” the disclosure destination “Domain Controller 001,” and the reason for a request “debug,” as the condition. The execution clause of such disclosure policy data item p indicates the disclosure level “High” and the disclosure period “24 h,” as the first execution mode.

Note that such disclosure policy data items p are associated in advance with a log data item stored in log storage 2 of low-level component 1b.

Disclosure processor 122 of disclosure executor 120 identifies, as a disclosure log data item, a log data item that is to be disclosed (i) in accordance with one or more request details satisfying a condition indicated by the conditional clause among the one or more request details indicated by request information m1 in disclosure request message m, and (ii) in a portion that is of a second execution mode indicated by request information m2 in disclosure request message m and overlaps the first execution mode indicated by the execution clause. That is, a disclosure range of the log data item to be disclosed is limited to a range within which the request range indicated by disclosure request message m overlaps the disclosable range indicated by disclosure policy data item p. The one or more request details indicated in disclosure request message m are limited to the condition in disclosure policy data item p, and the second execution mode in disclosure request message m is limited to the first execution mode in disclosure policy data item p.

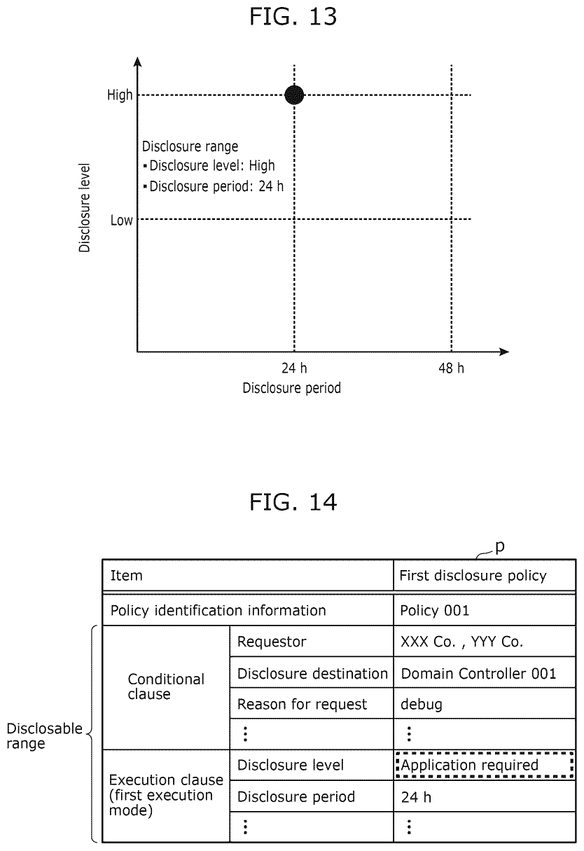

FIG. 13 is a diagram for describing an example of processing operation of disclosure processor 122.

As mentioned above, upon receiving disclosure request message m, disclosure processor 122 identifies a log data item corresponding to such disclosure request message m.

Disclosure processor 122 then obtains disclosure policy data item p corresponding to the identified log data item from policy storage 123. For example, disclosure processor 122 obtains disclosure policy data item p illustrated in (a) in FIG. 12. On the basis of such disclosure policy data item p, disclosure processor 122 determines a disclosable range of the log data item, for example, the conditional clause and the execution clause in (a) in FIG. 12. Disclosure processor 122 further determines a disclosure range that is within the disclosable range defined with the conditional clause and the execution clause and also within the request range indicated in disclosure request message m.

Specifically, disclosure processor 122 determines whether one or more request details indicated by request information m1 in disclosure request message m satisfy a condition indicated by the conditional clause in disclosure policy data item p. In the example in FIG. 11, request information m1 indicates, as the one or more request details, the requestor “XXX Co.,” the reason for a request “debug,” and the disclosure destination “Domain Controller 001.” In the example in (a) in FIG. 12, the conditional clause indicates, as the condition, the requestor “XXX Co., YYY Co.,” the disclosure destination “Domain Controller 001,” and the reason for a request “debug.” In this case, the requestor, the disclosure destination, and the reason for a request indicated by request information m1 are included in the requestor, the disclosure destination, and the reason for a request indicated by the conditional clause, respectively. Therefore, disclosure processor 122 determines that all of the one or more request details indicated by request information m1 in disclosure request message m satisfy the condition indicated by the conditional clause in disclosure policy data item p. In this case, disclosure processor 122 determines the disclosure destination “Domain Controller 001” indicated by request information m1 in disclosure request message m as a part of the disclosure range.

Next, disclosure processor 122 identifies a portion that is of a second execution mode indicated by request information m2 in disclosure request message m and overlaps a first execution mode indicated by the execution clause in disclosure policy data item p. Specifically, disclosure processor 122 determines either a request disclosure level indicated in request information m2 or a disclosure level indicated in the execution clause, whichever is lower. Disclosure processor 122 determines either a disclosure period indicated in request information m2 or a disclosure period indicated in the execution clause, whichever is shorter. In the example in FIG. 11, request information m2 indicates the request disclosure level “High” and the disclosure period “48 h.” In the example in (a) in FIG. 12, the execution clause indicates the disclosure level “High” and the disclosure period “24 h.” In this case, disclosure processor 122 determines the disclosure level “High” and the disclosure period “24 h” as a part of the disclosure range.

That is, disclosure processor 122 determines the disclosure destination “Domain Controller 001” indicated by request information m1 in disclosure request message m, and the disclosure level “High” and the disclosure period “24 h” as the disclosure range of the log data item. In other words, a disclosure log data item to be disclosed within the disclosure range is identified.

Note that, in the example mentioned above, disclosure policy data item p illustrated in (a) in FIG. 12 is obtained. In contrast, in the case where disclosure policy data item p illustrated in (b) in FIG. 12 is obtained, the disclosure destination is not determined in the disclosure range. That is, the disclosure destination and the reason for a request included in request information m1 in disclosure request message m illustrated in FIG. 11 are not included in a disclosure destination and a reason for the request in a conditional clause illustrated in (b) in FIG. 12. Therefore, disclosure processor 122 determines that the one or more request details indicated by request information m1 in disclosure request message m do not satisfy the condition indicated by the conditional clause in disclosure policy data item p. In this case, disclosure processor 122 does not recognize the disclosure destination “Domain Controller 001” indicated by request information m1 in disclosure request message m as a part of the disclosure range. As a result, no disclosure range is determined, and the transmission of a disclosure log data item is inhibited.

In the example mentioned above, the disclosure level indicated in the execution clause in disclosure policy data item p illustrated in (a) in FIG. 12 is “High.” In contrast, when the disclosure level is “Low,” disclosure processor 122 determines the disclosure level “Low” as a part of the disclosure range.

In the present embodiment, the first execution mode and the second execution mode are each defined with two parameters such as the disclosure level and the disclosure period. However, the first execution mode and the second execution mode may each be defined with another parameter. Alternatively, another parameter may be added as a parameter to define each of the first execution mode and the second execution mode. Also in the case where such a parameter is added, the disclosure range of the disclosure log data item may be determined on the basis of the magnitude of the parameter, as with the disclosure level and the disclosure period. That is, the disclosure range may be determined on the basis of either the parameter in the first execution mode and the parameter in the second execution mode, whichever is smaller or shorter. Alternatively, methods of determining the disclosure range on the basis of a parameter may be switched in accordance with the one or more request details indicated by request information m1 in disclosure request message m. For example, request information m1 in disclosure request message m indicates the requestor “XXX Co.,” which is among the requestor “XXX Co., YYY Co.” indicated in disclosure policy data item p illustrated in (a) in FIG. 12. In such a case, disclosure processor 122 determines the disclosure range on the basis of either of the parameters, whichever is smaller or shorter, as in the case mentioned above. In contrast, request information m1 in disclosure request message m indicates the requestor “YYY Co.,” which is among the requestor “XXX Co., YYY Co.” indicated in disclosure policy data item p illustrated in (a) in FIG. 12. In such a case, unlike the case mentioned above, disclosure processor 122 may determine the disclosure range on the basis of, for example, a parameter included in the execution clause in disclosure policy data item p. In the case of switching the methods of determining the disclosure range on the basis of the requestor or the like indicated in disclosure request message m, a scheme such as public key cryptography may be introduced for at least one of disclosure request message m or disclosure policy data item p so as to avoid a spoofed requestor.

FIG. 14 is a diagram illustrating another example of disclosure policy data item p.

The disclosure level included in the execution clause in disclosure policy data item p may be “application required” as in the example in FIG. 14. When the disclosure level “application required” is indicated in the execution clause in disclosure policy data item p, disclosure processor 122 queries an external system as to whether to adopt the request disclosure level indicated in request information m2. The external system may be server 200 or may be, for example, a system that is managed by a development vendor of low-level component 1b including such disclosure processor 122.

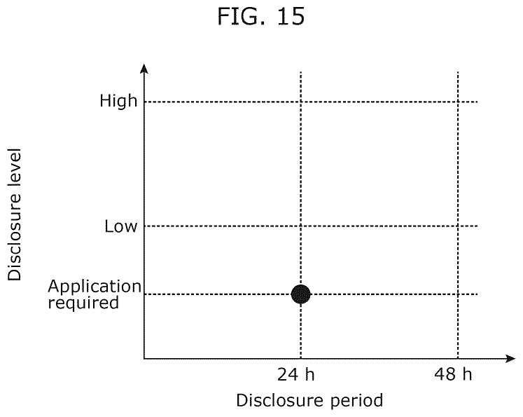

That is, in the case where the execution clause in disclosure policy data item p indicates an application to the external system outside information processing system 100 instead of the first execution mode, disclosure processor 122 queries the external system as to whether to disclose the log data item in the second execution mode (e.g., the request disclosure level) indicated in request information m2. FIG. 15 is a diagram for describing another example of the processing operation of disclosure processor 122.

As mentioned above, disclosure processor 122 determines either the request disclosure level indicated in request information m2 or the disclosure level indicated in the execution clause, whichever is lower. Here, in the case where the disclosure level indicated in the execution clause is “application required,” the disclosure level “application required” is defined to be lower than the disclosure level “Low” as illustrated in FIG. 15. Therefore, in this case, disclosure processor 122 determines that the disclosure level is “application required” irrespective of whether the request disclosure level is “High” or “Low.” As a result, disclosure processor 122 applies the request disclosure level indicated in request information m2 to the external system. In other words, disclosure processor 122 queries the external system as to whether to adopt the request disclosure level.

Alternatively, disclosure processor 122 may query the external system as to the disclosure level indicated in the execution clause. In this case, upon receiving the disclosure level indicated in the execution clause as a response from the external system, disclosure processor 122 determines, as a disclosure level that specifies the disclosure range of the log data item, either the received disclosure level or the request disclosure level indicated in request information m2, whichever is lower.

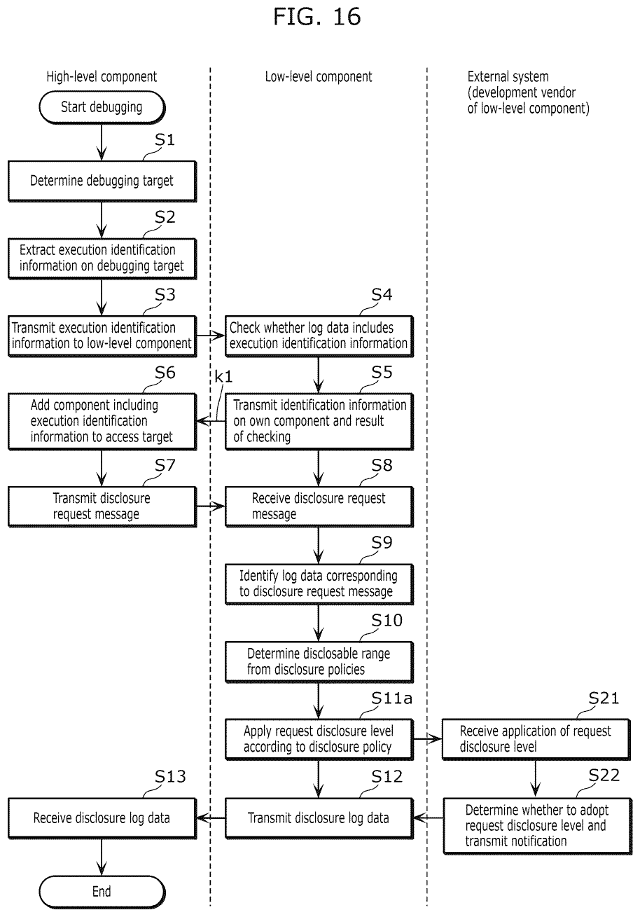

FIG. 16 is a sequence diagram illustrating another example of the processing operation of high-level component 1a and low-level component 1b. Note that FIG. 16 is a sequence diagram of the case where the disclosure level “application required” is indicated in the execution clause in disclosure policy data item p.

As in the example illustrated in FIG. 9, high-level component 1a and low-level component 1b executes the processing of steps S1 to S10. Here, the disclosure level indicated in the execution clause included in the disclosable range determined in step S10 is “application required.” As a result, disclosure processor 122 of low-level component 1b applies the request disclosure level indicated in disclosure request message m to the external system (step S11a). Specifically, disclosure processor 122 notifies the external system of the request disclosure level. Alternatively, disclosure processor 122 notifies the external system of the combination of the request disclosure level and the name of or the component identification information on high-level component 1a.

The external system receives the application of the request disclosure level (step S21). The external system then determines whether to adopt the request disclosure level and notifies low-level component 1b of a result of the determination (step S22). Disclosure processor 122 of low-level component 1b receives the notification of the above-mentioned result of the determination from the external system. When the result of the determination indicates that the request disclosure level is adopted, that is, the application is accepted, disclosure processor 122 identifies a log data item to be disclosed within the disclosure range specified by the request disclosure level, as the disclosure log data item. For example, when the request disclosure level is “High,” a disclosure log data item of the disclosure level “High” is identified. Disclosure processor 122 then transmits the disclosure log data item to high-level component 1a (step S12). High-level component 1a receives the disclosure log data item from low-level component 1b (step S13). When the external system determines in step S22 that the request disclosure level is not adopted, that is, the application is not accepted, disclosure processor 122 transmits no disclosure log data item in step S12.

In the example mentioned above, the result of the determination in step S22 is notified from the external system to low-level component 1b. However, the result of the determination may be notified to high-level component 1a rather than low-level component 1b. In this case, in step S11a, low-level component 1b may make a primary response to high-level component 1a. In a specific example, in step S11a, low-level component 1b transmits the application of the request disclosure level to the external system and additionally transits the disclosure log data item corresponding to the request disclosure level to the external system. In step S22, the external system determines to permit the application and then transmits a result of the determination and the disclosure log data item to high-level component 1a rather than low-level component 1b.

In the example mentioned above, the request disclosure level in the second execution mode is applied. However, not only the request disclosure level but also the disclosure period may be applied to the external system.

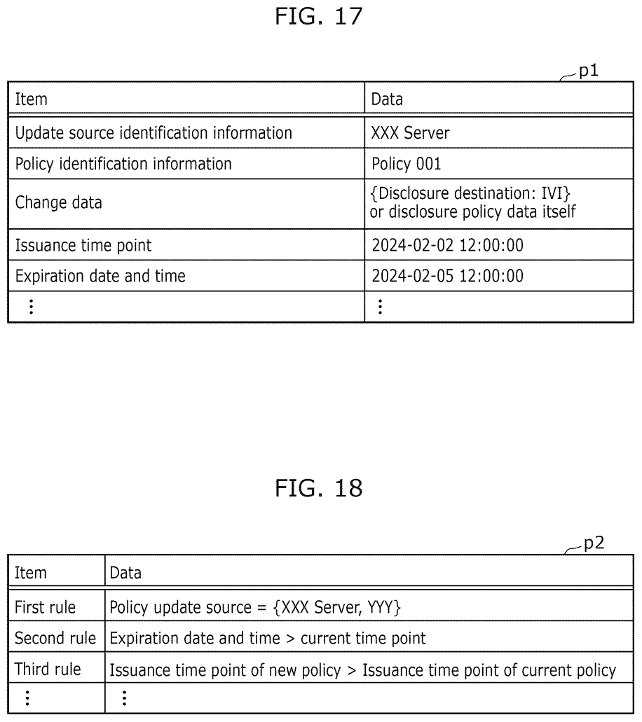

FIG. 17 is a diagram illustrating an example of an update message to be received by policy updater 150.

For example, a policy update source transmits update message p1 illustrated in FIG. 17 to policy updater 150. The policy update source may be, for example, component 1 included in information processing system 100, debugging device 300, server 200, or the like. Policy updater 150 receives such update message p1.

Update message p1 includes, for example, update source identification information, policy identification information, change data, an issuance time point, and an expiration date and time. The update source identification information is identification information for identifying the policy update source. A specific example of the update source identification information is “XXX Server.” The policy identification information is identification information for identifying disclosure policy data item p to be updated according to update message p1. A specific example of the policy identification information is “Policy 001.” The change data is new data that is changed or updated to in disclosure policy data item p. As a specific example, the change data is a new disclosure destination “In-vehicle infotainment (IVI)” or the entire new disclosure policy data item p. The issuance time point is a time point at which update message p1 is issued or generated, or a time point at which disclosure policy data item p is updated and issued according to update message p1. As a specific example, the issue time point is “2024 Feb. 2 12:00:00.” The expiration date and time is an expiration date and time of update message p1. A specific example of the expiration date and time is “2024 Feb. 5 12:00:00.”

FIG. 18 is a diagram illustrating an example of update rule p2 that is referred to by policy updater 150.

Update rule p2 is data that indicates one or more rules for updating disclosure policy data item p. For example, the one or more rules includes a first rule, a second rule, and a third rule. The first rule indicates update source identification information on one or more policy update sources that are capable of updating disclosure policy data item p (e.g., “XXX Server, YYY”). The second rule indicates that the expiration date and time of update message p1 for updating disclosure policy data item p is later than a current time point. The third rule indicates that the issuance time point of update message p1 for updating disclosure policy data item p is later than the issuance time point of update message p1 used for updating current disclosure policy data item p. Note that the first rule, the second rule, and the third rule are merely an example. Another rule may be indicated in update rule p2.

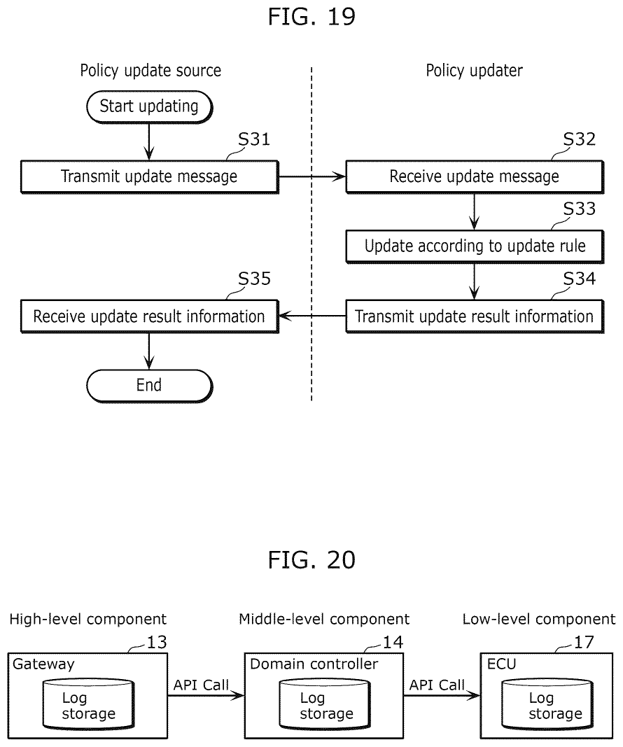

FIG. 19 is a sequence diagram illustrating an example of processing operation of a policy update source and policy updater 150.

First, the policy update source transmits update message p1 to policy updater 150 (step S31). Policy updater 150 receives such update message p1 (step S32). Referring to update rule p2, policy updater 150 determines whether it is possible to update disclosure policy data item p according to such update message p1.

For example, policy updater 150 determines whether the update source identification information in update message p1 conforms to the first rule in update rule p2, that is, whether the update source identification information is indicated in the first rule. Policy updater 150 also determines whether the expiration date and time in update message p1 conforms to the second rule in update rule p2, that is, whether the expiration date and time is later than the current time point. Policy updater 150 also determines whether the issuance time point in update message p1 conforms to the third rule in update rule p2, that is, whether the issuance time point is later than the issuance time point of update message p1 used for updating current disclosure policy data item p. When determining that the update message p1 conforms to at least one of the first rule, the second rule, or the third rule, policy updater 150 updates disclosure policy data item p that is identified with the policy identification information in such update message p1 (step S33). That is, policy updater 150 replaces a part of or the entirety of such disclosure policy data item p with the change data in update message p1. For example, when the change data is the disclosure destination “IVI,” policy updater 150 replaces the disclosure destination “Domain Controller 001” in disclosure policy data item p before the update with “IVI.” When the change data is new disclosure policy data item p itself, policy updater 150 replaces previous disclosure policy data item p before the update with such new disclosure policy data item p.

Policy updater 150 then transmits update result information indicating a result of the update in step S33 to the policy update source (step S34). The policy update source receives the update result information (step S35). Accordingly, on the basis of the update result information, the policy update source can determine whether the update has been performed. Note that the processing of steps S34 and S35 need not be performed. Alternatively, in step S34, policy updater 150 may transmit the update result information to component 1, a system, or a device different from the policy update source.

In the example mentioned above, disclosure policy data item p is updated when update message p1 conforms to at least one of the first rule, the second rule, and the third rule. However, disclosure policy data item p may be updated when update message p1 conforms to all of the first rule, the second rule, and the third rule. Alternatively, disclosure policy data item p may be updated when update message p1 conforms to any one of a rule group including one or more rules or a rule group including the other one or more rules. For example, disclosure policy data item p may be updated when update message p1 conforms to any one of a rule group including the first rule and the second rule or a rule group including the third rule. Note that update message p1 conforming to a rule group means that such update message p1 conforms all of one or more rules included in the rule group. How to sort rules into rule groups, rules to be included in a rule group, the number of rule groups, and the like may be defined in any manner. A logical expression itself, a control structure (If statement, etc.) in a program may be defined as a rule.

The first rule may indicate a plurality of update source identification information items and the priorities of the update source identification information items. For example, policy updater 150 receives update messages p1 from a plurality of policy update sources. That is, a conflict among updates occurs. In such a case, policy updater 150 identifies, according to the first rule, a policy update source corresponding to the highest priority among the priorities of the update source identification information items on the policy update sources. Policy updater 150 may then update disclosure policy data item p based on update message p1 that is transmitted from the identified policy update source. Alternatively, policy updater 150 identifies update message p1 that indicates the latest issuance time point or the farthest expiration date and time among such update messages p1. Policy updater 150 may then update disclosure policy data item p based on identified update message p1.

As described above, in the present embodiment, disclosure executor 120 of low-level component 1b receives disclosure request message m from high-level component 1a and identifies a log data item corresponding to such disclosure request message m. Disclosure executor 120 then determines a disclosable range of the identified log data item on the basis of disclosure policy data item p on the identified log data item. Furthermore, disclosure executor 120 transmits a disclosure log data item to high-level component 1a when the identified log data item includes the disclosure log data item that is to be disclosed in a disclosure range that is within the determined disclosable range and also within a request range indicated in disclosure request message m.

Accordingly, when low-level component 1b receives disclosure request message m from high-level component 1a, low-level component 1b may transmit a disclosure log data item to high-level component 1a. Thus, the disclosure log data item is disclosed in a disclosure range that is within the disclosable range based on disclosure policy data item p and also within the request range indicated in disclosure request message m. That is, using disclosure policy data item p, low-level component 1b can disclose the disclosure log data item in the disclosure range that is narrower than the request range indicated in disclosure request message m. As a result, low-level component 1b can disclose a disclosure log data item in a disclosure range according to the necessity of a log data item, without disclosing a log data item satisfying the entire request range indicated in disclosure request message m and without refusing to disclose a log data item. For example, it is possible to disclose a disclosure log data item in a disclosure range necessary for debugging. Accordingly, low-level component 1b can reduce the risk of the outflow of technology, and high-level component 1a can collect log data items appropriately. In addition, it is possible to reduce the time, the consumption of processing resources, and the like that are necessary to collect log data items. Note that if there is no disclosure range that is within a disclosable range based on disclosure policy data item p and also within a request range indicated in disclosure request message m, low-level component 1b need not transmit a disclosure log data item and may refuse a request with disclosure request message m.

In the present embodiment, since disclosure request message m including first execution identification information is transmitted, high-level component 1a can send, to low-level component 1b, the designation of a log data item to be requested for disclosure. With the first execution identification information, low-level component 1b can appropriately identify a log data item requested by high-level component 1a.

In the present embodiment, before disclosure request message m is transmitted, a list indicating one or more components 1 each including a log data item to which second execution identification information has been added is generated. Each of the one or more components 1 indicated in the list is set as an access target of disclosure request message m, that is, a destination of disclosure request message m. Thus, it is possible to transmit disclosure request message m to appropriate destinations, thus making the transmission of such disclosure request message m efficient. That is, it is possible to reduce needless processing such as transmitting disclosure request message m to another component 1 other than components 1 each including a log data item to which second execution identification information has been added, to cause the other component 1 to execute processing corresponding to disclosure request message m.

In the present embodiment, one or more disclosure policy data items p stored in policy storage 123 are updated, and it is thus possible to appropriately adjust the disclosure range of a disclosure log data item.

In the present embodiment, log storage 2 of low-level component 1b stores, for each request from high-level component 1a, a log data item to which second execution identification information corresponding to the request is added. In addition, the second execution identification information is information obtained from high-level component 1a. For example, high-level component 1a executes processing and requests low-level component 1b to perform other processing necessary for the processing. At this time, high-level component 1a can cause low-level component 1b to add second execution identification information transmitted by high-level component 1a to a log data item of the other processing corresponding to the request. As a result, high-level component 1a can identify, using the second execution identification information, a log data item of a series of processes performed together with low-level component 1b.

In the present embodiment, a disclosure log data item is encrypted by low-level component 1b and transmitted to high-level component 1a. Therefore, it is possible to increase the confidentiality of the disclosure log data item. For example, the disclosure log data item that has been encrypted, that is, an encrypted disclosure log data item is transmitted from low-level component 1b to high-level component 1a via another component 1. In such a case, it is possible to restrain the content of the encrypted disclosure log data item from being decrypted by the other component 1.

In the present embodiment, a disclosure log data item is disclosed in accordance with one or more request details satisfying a condition indicated in disclosure policy data item p among one or more request details indicated by disclosure request message m, and in a portion that is of a second execution mode indicated in disclosure request message m and overlaps a first execution mode indicated by disclosure policy data item p. Therefore, it is possible to limit a request with a request detail and a second execution mode indicated in disclosure request message m in accordance with a condition and a first execution mode indicated by disclosure policy data item p. As a result, it is possible to appropriately limit the disclosure of a log data item.

In the present embodiment, in the case where an execution clause in disclosure policy data item p indicates an application to an external system outside information processing system 100, disclosure executor 120 of low-level component 1b queries the external system as to whether to disclose a log data item in a second execution mode indicated in disclosure request message m. Therefore, in the case where the external system permits the disclosure of the log data item in the second execution mode, it is possible to disclose a disclosure log data item in the form of the disclosure of the log data item in the second execution mode. Conversely, in the case where the external system does not permit the disclosure of the log data item in the second execution mode, it is possible to inhibit the disclosure of the log data item in the second execution mode, that is, the disclosure of the disclosure log data item. Therefore, it is possible to appropriately control the disclosure of a log data item with an external system.

In the present embodiment, when log aggregator 114 receives a disclosure log data item from each of two or more components 1, log aggregator 114 aggregates two or more disclosure log data items and outputs the aggregated two or more disclosure log data items. Therefore, for example, it is possible to display the disclosure log data items on a display in an arranged manner. As a result, by referring to the disclosure log data items, for example, it is possible to easily perform the analysis of a bug or debugging.

### Embodiment 2

In Embodiment 1, a series of processes is performed by high-level component 1a and low-level component 1b. In contrast, in the present embodiment, a series of processes is performed by high-level component 1a, low-level component 1b, and additionally a middle-level component.

FIG. 20 is a diagram illustrating an example of a series of processes performed by a plurality of components 1 including the middle-level component.

For example, as illustrated in FIG. 20, the series of processes is performed by gateway 13 equivalent to high-level component 1a, ECU 17 equivalent to low-level component 1b, and domain controller 14 equivalent to the middle-level component. Specifically, gateway 13 calls a function of domain controller 14 via an API to execute a process. As a result, domain controller 14 executes a process corresponding to the called function. At this time, domain controller 14 calls a function of ECU 17 via an API. That is, gateway 13 serves as high-level component 1a to request domain controller 14 to perform a process. In addition, domain controller 14 receiving the request serves as the middle-level component to request ECU 17 equivalent to low-level component 1b to perform a process. Accordingly, the series of processes is executed by gateway 13, domain controller 14, and ECU 17.

Note that gateway 13 equivalent to high-level component 1a may call functions of a plurality of middle-level components via APIs, and the middle-level components may call functions of a plurality of low-level components 1b via APIs.

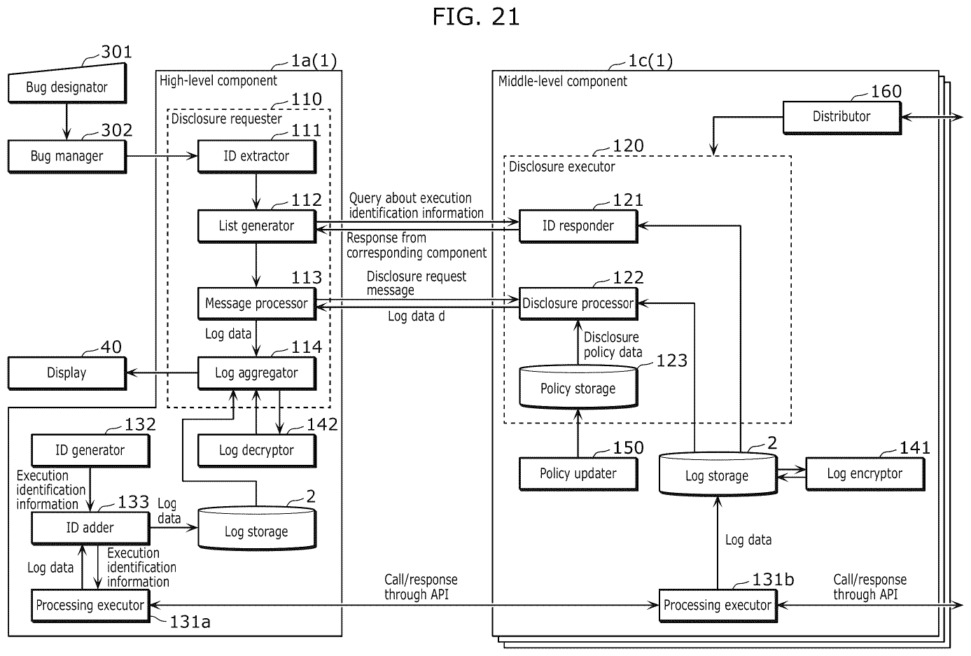

FIG. 21 is a diagram illustrating an example of the configurations of high-level component 1a and the plurality of middle-level components in the present embodiment.

Each of middle-level components 1c is component 1 included in information processing system 100, executes a process in response to a call via an API from high-level component 1a, and calls a function of low-level component 1b via an API to execute the process.

Such middle-level component 1c includes the constituent elements of low-level component 1b in Embodiment 1 and further includes distributor 160. Therefore, middle-level component 1c may be called a second component.

Processing executor 131b of middle-level component 1c executes a process similar to the process executed by processing executor 131b in Embodiment 1 and calls a function of low-level component 1b via an API. In response to the call from middle-level component 1c, low-level component 1b executes a process corresponding to the called function as in the call from high-level component 1a. As a result, processing executor 131b of middle-level component 1c receives a response to the call from low-level component 1b and responds to high-level component 1a.

Distributor 160 distributes data or information. That is, distributor 160 transmits, to low-level component 1b, data or information that is transmitted by high-level component 1a and received by disclosure executor 120. For example, when ID responder 121 of disclosure executor 120 receives execution identification information (i.e., first execution identification information) from high-level component 1a, distributor 160 transmits the execution identification information to low-level component 1b. When disclosure processor 122 of disclosure executor 120 receives disclosure request message m from high-level component 1a, distributor 160 transmits such disclosure request message m to low-level component 1b. For example, another component identification information item different from a component identification information item on middle-level component 1c including such distributor 160 is set as an access target in such disclosure request message m. In such a case, distributor 160 may transmit such disclosure request message m to low-level component 1b that is identified with the other component identification information. Note that, the component identification information item on middle-level component 1c including such distributor 160 may also be set to the access target.

That is, disclosure request message m transmitted from high-level component 1a indicates, as an access target, each of one or more components 1 indicated in a list generated by list generator 112. In the case where the one or more components 1 include, as an access target, another component 1 except middle-level component 1c, distributor 160 transmits disclosure request message m received by disclosure executor 120 to such component 1.

On the other hand, distributor 160 receives data or information transmitted from low-level component 1b and transmits the data or information to high-level component 1a via disclosure executor 120. For example, upon receiving response information k1 mentioned above from ID responder 121 of low-level component 1b, distributor 160 transmits such response information k1 to high-level component 1a via disclosure executor 120. In addition, upon receiving a disclosure log data item from disclosure processor 122 of low-level component 1b, distributor 160 transmits the disclosure log data item to high-level component 1a via disclosure executor 120.

Note that middle-level component 1c in the present embodiment also executes the process executed by low-level component 1b in Embodiment 1. Low-level component 1b in the present embodiment communicates with high-level component 1a via middle-level component 1c to execute a process similar to that executed by low-level component 1b in Embodiment 1.

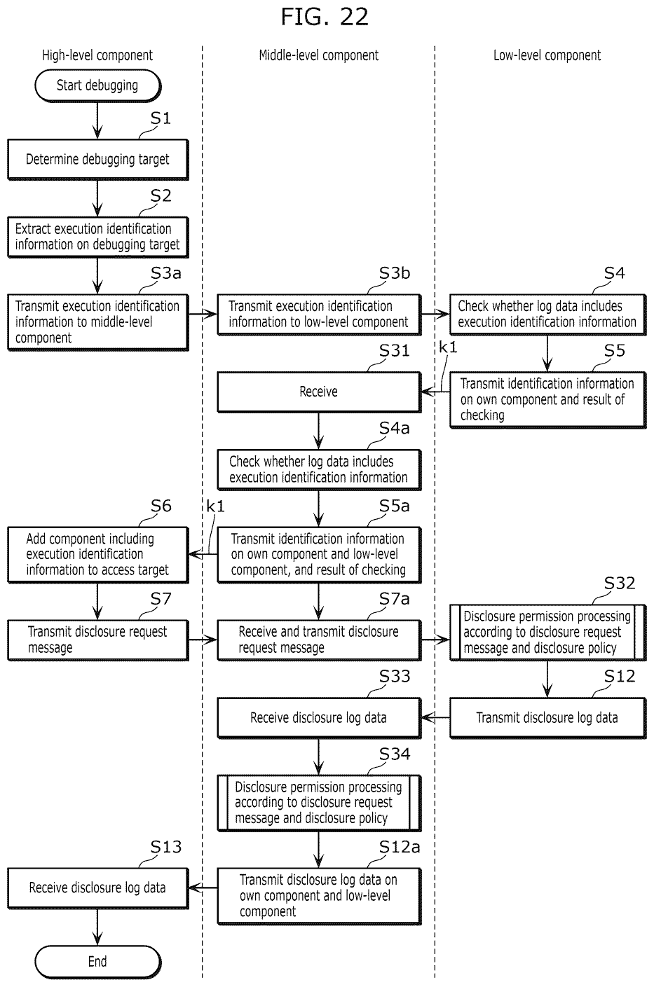

FIG. 22 is a sequence diagram illustrating an example of processing operation of high-level component 1a, middle-level component 1c, and low-level component 1b.

First, when debugging is started, high-level component 1a executes processing of steps S1 and S2 as in Embodiment 1. List generator 112 then transmits the execution identification information to middle-level component 1c to query such middle-level component 1c (step S3a). When ID responder 121 of middle-level component 1c receives the execution identification information from high-level component 1a, distributor 160 of middle-level component 1c transmits the execution identification information to low-level component 1b (step S3b). Accordingly, the query about the execution identification information is also put to low-level component 1b. Upon receiving the execution identification information from middle-level component 1c, low-level component 1b executes processing of steps S4 and S5 as in Embodiment 1. Note that, in step S5, ID responder 121 of low-level component 1b transmits response information k1 to middle-level component 1c.

Distributor 160 of middle-level component 1c receives response information k1 from low-level component 1b (step S31). Distributor 160 then outputs such response information k1 to ID responder 121 of middle-level component 1c. Upon obtaining response information k1 from such low-level component 1b, ID responder 121 of middle-level component 1c executes, in middle-level component 1c, processing similar to steps S4 and S5 performed in low-level component 1b (steps S4a and S5a).

That is, ID responder 121 of middle-level component 1c checks whether a log data item to which the execution identification information transmitted from high-level component 1a has been added is stored in log storage 2 of middle-level component 1c (step S4a). That is, ID responder 121 checks whether any log data item stored in log storage 2 includes the execution identification information. Here, ID responder 121 checks that a log data item includes the execution identification information. At this time, ID responder 121 transmits, to high-level component 1a, response information k1 that includes a result of the checking and component identification information, which is identification information on middle-level component 1c including such ID responder 121 (i.e., identification information on the own component) (step S5a). In step S5a, ID responder 121 collectively transmits response information k1 from low-level component 1b received in step S31 and response information k1 from middle-level component 1c mentioned above to high-level component 1a.

Upon receiving response information items k1 mentioned above, high-level component 1a executes processing of steps S6 and S7 as in Embodiment 1. Note that, in step S7, message processor 113 of high-level component 1a transmits disclosure request message m to middle-level component 1c included in the access target.

Disclosure processor 122 of middle-level component 1c receives such disclosure request message m from high-level component 1a. Distributor 160 of middle-level component 1c then transmits such disclosure request message m to low-level component 1b included in the access target (step S7a). Disclosure processor 122 of low-level component 1b receives such disclosure request message m from middle-level component 1c and executes disclosure permission processing according to disclosure request message m and disclosure policy data item p (step S32). In step S32, processing similar to steps S8 to S11 in Embodiment 1 is executed. Disclosure processor 122 of low-level component 1b then transmits a disclosure log data item identified in processing of step S32 to middle-level component 1c (step S12).

Distributor 160 of middle-level component 1c receives the disclosure log data item from low-level component 1b (step S33). Distributor 160 then outputs the disclosure log data item to disclosure processor 122 of middle-level component 1c. Upon obtaining the disclosure log data item, disclosure processor 122 of middle-level component 1c executes, in middle-level component 1c, processing similar to the processing of step S32 performed in low-level component 1b (step S34). As a result, a disclosure log data item is identified in middle-level component 1c. Disclosure processor 122 of middle-level component 1c then transmits, to high-level component 1a, the disclosure log data item in low-level component 1b received in step S33 and the disclosure log data item in middle-level component 1c identified in step S34 (step S12a).

As a result, high-level component 1a receives, from middle-level component 1c, the disclosure log data item in low-level component 1b and the disclosure log data item in middle-level component 1c (step S13).

Note that, in step S12, low-level component 1b may encrypt the disclosure log data item using a common-key and may transmit an encrypted disclosure log data item generated by the encryption to middle-level component 1c. The common-key is an encryption key retained in common with high-level component 1a. The common-key is not retained in middle-level component 1c. Accordingly, even when middle-level component 1c receives, in step S33, a disclosure log data item in low-level component 1b (i.e., an encrypted disclosure log data item), it is possible to restrain the disclosure log data item from being decrypted by middle-level component 1c. Alternatively, low-level component 1b may transmit, in step S12, the disclosure log data item to high-level component 1a via another middle-level component 1c. The other middle-level component 1c is component 1 that belongs to the same disclosure level of low-level component 1b.

In the example mentioned above, there is one middle-level component 1c between high-level component 1a and low-level component 1b. However, the number of such middle-level components 1c may be more than one. In the above-mentioned example, the number of layers of components 1 is three. That is, high-level component 1a, middle-level component 1c, and low-level component 1b constitute the three layers. However, the number of layers may be four or more. In this case, the number of layers of middle-level components 1c may be more than one. In the case where middle-level component 1c is present in any one of the plurality of layers, low-level component 1b may be present in the same layer as such middle-level component 1c. In addition, the configuration of the layers may be dynamically determined. That is, the structure of the plurality of components 1 may be one in which layers cannot be defined, having what is called a network-like topology. In this case, which of components 1 serves as high-level component 1a and which of components 1 serves as low-level component 1b may be dynamically determined according to certain designation such as an API call relationship or which of components 1 is used to debug.

As described above, in the present embodiment, middle-level component 1c includes distributor 160. Accordingly, disclosure request message m can be distributed from high-level component 1a to low-level component 1b via middle-level component 1c. As a result, high-level component 1a can receive a disclosure log data item from not only middle-level component 1c but also low-level component 1b, and thus it is possible to collect log data items effectively.

High-level component 1a in Embodiments 1 and 2 is an information processing device including ID extractor 111, list generator 112, and message processor 113. ID extractor 111 extracts, from input information, first execution identification information for identifying a log data item to be requested. List generator 112 transmits the first execution identification information to each of a plurality of external devices and generates, based on a response result from one or more external devices each including a log data item to which second execution identification information corresponding to the first execution identification information has been added among the plurality of external devices, a list indicating the one or more external devices. Message processor 113 transmits disclosure request message m indicating a request range in which the disclosure of the log data item is requested, to at least one of the one or more external devices indicated in the list. Disclosure request message m includes the first execution identification information extracted by ID extractor 111 and indicates the one or more external devices indicated in the list as access targets. For example, each external device is equivalent to a second component or low-level component 1b.

Accordingly, the information processing device can obtain a log data item according to a request range from at least one of the one or more external devices by transmitting disclosure request message m to the at least one external device. Since disclosure request message m including the first execution identification information is transmitted, the information processing device can send, to the external device, the designation of a log data item to be requested for disclosure. With the first execution identification information, the external device can appropriately identify a log data item requested by the information processing device. In addition, before disclosure request message m is transmitted, the list indicating the one or more external devices each including a log data item to which the second execution identification information has been added is generated. Each of the one or more external devices indicated in the list is set as an access target of the disclosure request message, that is, a destination of the disclosure request message. Thus, it is possible to transmit the disclosure request message to appropriate destinations, thus making the transmission of the disclosure request message efficient. That is, it is possible to reduce needless processing such as transmitting a disclosure request message to another external device other than external devices each including a log data item to which the second execution identification information has been added, to cause the other external device to execute processing corresponding to the disclosure request message. As a result, it is possible to appropriately collect log data items.

Low-level component 1b or middle-level component 1c in Embodiments 1 and 2 is an information processing device including log storage 2 and disclosure executor 120. Log storage 2 stores one or more log data items. Disclosure executor 120 receives, from an external device, disclosure request message m indicating a request range in which the disclosure of a log data item is requested, and identifies the log data item corresponding to disclosure request message m from among the one or more log data items stored in log storage 2. Next, disclosure executor 120 determines a disclosable range of the identified log data item, on the basis of disclosure policy data item p indicating, as a disclosure policy, a policy regarding the disclosure of the identified log data item. Disclosure executor 120 then transmits a disclosure log data item to the external device when the identified log data item includes the disclosure log data item that is to be disclosed in a disclosure range that is within the determined disclosable range and also within a request range indicated in disclosure request message m. For example, the external device is equivalent to a first component or high-level component 1a.

Accordingly, when the information processing device receives disclosure request message m from the external device, the information processing device may transmit the disclosure log data item to the external device. Thus, the disclosure log data item is disclosed in a disclosure range that is within the disclosable range based on disclosure policy data item p and also within the request range indicated in disclosure request message m. That is, using disclosure policy data item p, the information processing device can disclose the disclosure log data item in the disclosure range that is narrower than the request range indicated in disclosure request message m. As a result, the information processing device can disclose the disclosure log data item in a disclosure range according to the necessity of a log data item, without disclosing a log data item satisfying the entire request range indicated in disclosure request message m and without refusing to disclose a log data item. For example, it is possible to disclose a disclosure log data item in a disclosure range necessary for debugging. Accordingly, the external device can appropriately collect log data items. Note that if there is no disclosure range that is within a disclosable range based on disclosure policy data item p and also within a request range indicated in disclosure request message m, the information processing device need not transmit a disclosure log data item.

Component 1 in Embodiments 1 and 2 may be an information processing device that includes both a function of high-level component 1a and a function of low-level component 1b or middle-level component 1c. Such an information processing device includes message processor 113, log storage 2, and disclosure executor 120. Message processor 113 transmits, to a first external device, first disclosure request message m indicating a request range in which the disclosure of a log data item is requested. Log storage 2 stores one or more log data items. Disclosure executor 120 receives, from a second external device, second disclosure request message m indicating a request range and identifies the log data item corresponding to second disclosure request message m from among one or more log data items stored in log storage 2. Next, disclosure executor 120 determines a disclosable range of the identified log data item, on the basis of disclosure policy data item p indicating, as a disclosure policy, a policy regarding the disclosure of the identified log data item. Disclosure executor 120 then transmits a disclosure log data item to the second external device when the identified log data item includes the disclosure log data item that is to be disclosed in a disclosure range that is within the determined disclosable range and also within a request range indicated in second disclosure request message m.

Accordingly, it is possible to exhibit the same actions and effects as those of low-level component 1b mentioned above and to request a log data item from the first external device as with high-level component 1a.

### OTHER EMBODIMENTS

Although the information processing systems according to one or more aspects of the present disclosure have been described based on Embodiments 1 and 2, the present disclosure is not limited to these embodiments. Those skilled in the art will readily appreciate that embodiments arrived at by making various modifications to the above embodiments or embodiments arrived at by selectively combining Embodiments 1 and 2 without materially departing from the scope of the present disclosure may be included within one or more aspects of the present disclosure.

In Embodiments 1 and 2 described above, the disclosure level is expressed in two levels: “Low” and “High.” However, the disclosure level may be expressed in three or more levels. Also in this case, the disclosure range is limited at either the request disclosure level indicated in disclosure request message m or the disclosure level indicated in disclosure policy data item p, whichever is smaller or lower.

In Embodiments 1 and 2 described above, the execution identification information is distributed. The distribution of the execution identification information may be performed in a pseudo manner. For example, when performing the series of processes using an API, processing executor 131a of high-level component 1a and processing executor 131b of low-level component 1b or middle-level component 1c add, to their log data items, API information including a time point at which the API is called, a parameter of the API, the type of the API, as the second execution identification information. With this API information, the log data item in high-level component 1a and the log data item of low-level component 1b or middle-level component 1c are associated with each other. In this case, ID responder 121 receives, from list generator 112, a query about the log data item to which the API information has been added, as a query about a log data item to which the first execution identification information has been added. ID responder 121 then performs matching between the API information being queried about and the API information items in the log data items stored in log storages 2, thereby searching for a log data item to which the API information being queried about has been added. Likewise, disclosure processor 122 performs matching between API information included in disclosure request message m and the API information items in the log data items stored in log storages 2, thereby determining a log data item to which the API information included in disclosure request message m has been added.

In Embodiments 1 and 2 described above, the first execution identification information and the second execution identification information need not be in one-to-one correspondence. For example, in the case where the first execution identification information indicates a time point at which processing is performed, there may be a plurality of functions or APIs that may be executed during a period including the time point. A candidate for the functions or the APIs that may have been called may be taken as the second execution identification information. That is, a time point at which a function or an API is executed during the period may be used as the second execution identification information.

In the case where which of low-level components 1b has been called is obvious from, for example, the type of an API called by high-level component 1a, high-level component 1a may solely generate the above-mentioned list indicating one or more low-level components 1b, without querying one or more low-level components 1b.

Note that, in the above-described embodiments, each of the constituent elements may be configured with dedicated hardware or may be implemented by the execution of a software program suitable for the constituent element. Each constituent element may be implemented by a program executor such as a central processing unit (CPU) or a processor reading and executing a software program recorded in a recording medium such as a hard disk or a semiconductor memory. Here, a program that is software implementing a device such as each component 1 or a system in the above-described embodiments causes a computer to execute the steps included in the sequence diagrams in FIG. 9, FIG. 16, FIG. 19, and FIG. 22.

It should be noted that the present disclosure may also include the following embodiments.
(1) Each of one or more devices described above may specifically be a computer system including, for example, a microprocessor, ROM (Read Only Memory), and RAM (Random Access Memory), a hard disk unit, a display unit, a keyboard, a mouse, and the like. The RAM or the hard disk unit holds a computer program. The microprocessor operates according to the computer program to cause each of the one or more devices described above to execute its function. Here, the computer program includes combinations of instruction codes for issuing instructions to the computer to execute predetermined functions.
(2) A part or all of constituent elements in each of the one or more devices described above may be implemented into a single Large Scale Integration (LSI). The system LSI is a multi-functional LSI in which a plurality of elements are integrated into a single chip. An example of such a system LSI is a computer system including a microprocessor, a ROM, a Random Access Memory (RAM), and the like. The microprocessor operates according to the computer program to cause the system LSI to execute its function.
(3) A part or all of the constituent elements included in each of the one or more devices described above may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to execute its functions. The IC card or the module may have tamper resistance.
(4) The present disclosure may be the above-described methods. These methods may be a computer program executed by a computer, or digital signals forming the computer program. The present disclosure may be a computer-readable recording medium on which the computer program or the digital signals are recorded. Examples of the computer-readable recording medium are a flexible disk, a hard disk, a Compact Disc-Read Only Memory (CD-ROM), a magnetooptic disk (MO), a Digital Versatile Disc (DVD), a DVD-ROM, a DVD-RAM, a BD (Blu-ray (registered trademark) Disc), and a semiconductor memory. The present disclosure may be the digital signals recorded on the recording medium.

The present disclosure may be implemented by transmitting the computer program or the digital signals via an electric communication line, a wired or wireless communication line, a network represented by the Internet, data broadcasting, and the like.

It is also possible that the program or the digital signals may be recorded onto the recording medium to be transferred, or may be transmitted via a network or the like, so that the program or the digital signals can be executed by a different independent computer system.

Further Information about Technical Background to this Application

The disclosure of the following patent application including specification, drawings, and claims is incorporated herein by reference in their entirety: Japanese Patent Application No. 2024-046413 filed on Mar. 22, 2024.

### INDUSTRIAL APPLICABILITY

The information processing system according to the present disclosure is applicable to, for example, a system, a device, or the like that collects log data items for debugging.

1. An information processing system comprising:
a first component; and
a second component, wherein
the first component includes:
a memory; and
a first processor connected to the memory,
the first processor serves as a message processor that transmits, to the second component, a disclosure request message indicating a request range in which disclosure of a log data item is requested,
the second component includes:
a log memory in which one or more log data items are stored; and
a second processor serving as a disclosure executor, and
the disclosure executor:
receives the disclosure request message from the first component;
identifies the log data item corresponding to the disclosure request message from among the one or more log data items stored in the log memory;
determines a disclosable range of the log data item identified, based on a disclosure policy data item indicating, as a disclosure policy, a policy regarding disclosure of the log data item identified; and
transmits a disclosure log data item to the first component, when the log data item identified includes the disclosure log data item that is to be disclosed in a disclosure range that is within the disclosable range determined and also within the request range indicated in the disclosure request message.

2. The information processing system according to claim 1, wherein
the first processor of the first component further serves as:
an extractor that extracts, from input information, first execution identification information for identifying the log data item to be requested,
the message processor further generates the disclosure request message including the first execution identification information extracted by the extractor, and
the disclosure executor of the second component identifies, as the log data item corresponding to the disclosure request message, a log data item to which second execution identification information corresponding to the first execution identification information has been added from among the one or more log data items stored in the log memory.

3. The information processing system according to claim 2, comprising:
three or more components including the first component and the second component, wherein
the first processor of the first component further serves as:
a list generator that (i) transmits the first execution identification information to each of a plurality of components including the second component among the three or more components, and (ii) generates, based on a response result from one or more components each including a log data item to which the second execution identification information corresponding to the first execution identification information has been added among the plurality of components, a list indicating the one or more components including the second component, and
the message processor:
transmits the disclosure request message indicating, as an access target, each of the one or more components indicated in the list.

4. The information processing system according to claim 3, wherein
the second processor of the second component further serves as:
a distributor that transmits the disclosure request message received by the disclosure executor to an other component except the second component among the one or more components, when the one or more components include the other component as the access target.

5. The information processing system according to claim 1, wherein
the second component further includes:
a policy memory in which one or more disclosure policy data items are stored, the one or more disclosure policy data items corresponding to the one or more log data items stored in the log memory,
the second processor of the second component further serves as a policy updater that updates the one or more disclosure policy data items, and
the one or more disclosure policy data items include the disclosure policy data item corresponding to the log data item identified.

6. The information processing system according to claim 3, wherein
the second processor of the second component further serves as:
a processing executor that obtains, from the first component, the second execution identification information corresponding to a request each time the request is received from the first component, and executes processing corresponding to the request, and
each time the processing corresponding to the request is executed, the processing executor (i) adds the second execution identification information corresponding to the request to a log data item indicating a result of the processing corresponding to the request, and (ii) stores, in the log memory, the log data item to which the second execution identification information has been added.

7. The information processing system according to claim 1, wherein
the second processor of the second component further serves as:
a log encryptor that generates an encrypted disclosure log data item by encrypting the log data item identified or by encrypting the disclosure log data item,
the disclosure executor transmits the disclosure log data item by transmitting the encrypted disclosure log data item, and
the first processor of the first component further serves as:
a log decryptor that decrypts the encrypted disclosure log data item when the first component receives the encrypted disclosure log data item.

8. The information processing system according to claim 1, wherein
the disclosure policy data item indicates the disclosable range that includes a conditional clause and an execution clause,
the conditional clause indicates a condition for the disclosure of the log data item identified,
the execution clause indicates a first execution mode that is a mode of the disclosure of the log data item identified, the disclosure request message indicates:
one or more request details for the disclosure of the log data item identified; and
a second execution mode that is a mode requested for the disclosure of the log data item identified, and
the disclosure executor of the second component further identifies, as the disclosure log data item, a log data item that is to be disclosed (i) in accordance with at least one request detail satisfying the condition indicated by the conditional clause among the one or more request details indicated in the disclosure request message, and (ii) in a portion of the second execution mode indicated in the disclosure request message, the portion overlapping the first execution mode indicated by the execution clause.

9. The information processing system according to claim 8, wherein
when the execution clause indicates, instead of the first execution mode, an application to an external system outside the information processing system,
the disclosure executor of the second component queries the external system whether or not to disclose the log data item in the second execution mode.

10. The information processing system according to claim 1, comprising:
three or more components including the first component and the second component, wherein
the first processor of the first component further serves as:
an aggregator that aggregates two or more disclosure log data items and outputs the two or more disclosure log data items aggregated, when the aggregator receives the two or more disclosure log data items from two or more components including the second component among the three or more components.

11. An information processing device comprising:
a memory; and
a processor connected to the memory, wherein
the processor serves as:
an extractor that extracts, from input information, first execution identification information for identifying a log data item to be requested;
a list generator that (i) transmits the first execution identification information to each of a plurality of external devices, and (ii) generates, based on a response result from one or more external devices each including a log data item to which second execution identification information corresponding to the first execution identification information has been added among the plurality of external devices, a list indicating the one or more external devices; and
a message processor that transmits a disclosure request message indicating a request range in which disclosure of the log data item is requested, to at least one of the one or more external devices indicated in the list, and
the disclosure request message includes the first execution identification information extracted by the extractor, and indicates the one or more external devices indicated in the list as access targets.

12. An information processing device comprising:
a log memory in which one or more log data items are stored; and
a processor, wherein
the processor:
receives, from an external device, a disclosure request message indicating a request range in which disclosure of a log data item is requested;
identifies the log data item corresponding to the disclosure request message from among the one or more log data items stored in the log memory;
determines a disclosable range of the log data item identified, based on a disclosure policy data item indicating, as a disclosure policy, a policy regarding disclosure of the log data item identified; and
transmits a disclosure log data item to the external device, when the log data item identified includes the disclosure log data item that is to be disclosed in a disclosure range that is within the disclosable range determined and also within the request range indicated in the disclosure request message.

13. An information processing device comprising:
a processor serving as:
a message processor that transmits, to a first external device, a first disclosure request message indicating a request range in which disclosure of a log data item is requested; and
a disclosure executor; and
a log memory in which one or more log data items are stored, wherein
the disclosure executor:
receives a second disclosure request message indicating the request range from a second external device;
identifies the log data item corresponding to the second disclosure request message from among the one or more log data items stored in the log memory;
determines a disclosable range of the log data item identified, based on a disclosure policy data item indicating, as a disclosure policy, a policy regarding disclosure of the log data item identified; and
transmits a disclosure log data item to the second external device, when the log data item identified includes the disclosure log data item that is to be disclosed in a disclosure range that is within the disclosable range determined and also within the request range indicated in the second disclosure request message.

14. An information processing method performed by a first component and a second component each being a device, the information processing method comprising:
transmitting, from the first component to the second component, a disclosure request message indicating a request range in which disclosure of a log data item is requested, receiving, by the second component, the disclosure request message from the first component;
identifying, by the second component, the log data item corresponding to the disclosure request message from among one or more log data items stored in a log memory;
determining, by the second component, a disclosable range of the log data item identified, based on a disclosure policy data item indicating, as a disclosure policy, a policy regarding disclosure of the log data item identified; and
transmitting a disclosure log data item from the second component to the first component, when the log data item identified includes a disclosure log data item that is to be disclosed in a disclosure range that is within the disclosable range determined and also within the request range indicated in the disclosure request message.
